(19) United States
(12) Patent Application Publication
(10) Pub. No.: US 2023/0402927 A1
(43) Pub. Date: Dec. 14, 2023

(54) POWER CONVERSION UNIT AND POWER CONVERSION DEVICE

(71) Applicant: Mitsubishi Electric Corporation, Tokyo (JP)

(72) Inventor: Yu KAWAI, Chiyoda-ku, Tokyo (JP)

(73) Assignee: Mitsubishi Electric Corporation, Tokyo (JP)

(21) Appl. No.: 18/036,415

(22) PCT Filed: Dec. 8, 2020
(86) PCT No.: PCT/JP2020/045675

§ 371 Date: May 11, 2023

(51) Int. Cl. H02M 3/335

(52) U.S. Cl. CPC H02M 3/3353; H02M 3/33561

(57) ABSTRACT

A power conversion unit includes an input end to connect with a DC power supply, a first DC voltage end configured of a first terminal and a second terminal, a second DC voltage end configured of a third terminal and a fourth terminal, a converter, and a controller that controls the converter. The converter performs DC/DC conversion accompanied by power transmission between the input end and the first and second DC voltage ends. The controller generates a control command for the converter controlling a first voltage at the first DC voltage end and a second voltage at the second DC voltage end to a voltage target value.

### TECHNICAL FIELD

The present disclosure relates to a power conversion unit and a power conversion device including a plurality of the power converter units.

### BACKGROUND ART

A universal charge device charging an electric powered vehicle including an electric vehicle, an electric cart, an electric motorcycle, and the like is disclosed in Japanese National Patent Publication No. 2012-518987 (PTL 1). In such an application, the power conversion device needs to take different measures depending on a number of connected electric powered vehicles, a charging speed of the electric powered vehicle, and a condition of a power system to which the power conversion device is connected.

PTL 1 describes a device configuration in which a plurality of converters (charge packs or charge modules) are connected to a plurality of electric vehicles through a common mesh portion as a configuration capable of coping with a plurality of electric vehicle connections and various conditions of a charge speed of the electric vehicle although the device configuration is limited to the charge. Furthermore, the mesh portion switches a connection destination of the electric vehicle and the converter according to a charge state of the plurality of electric vehicles, whereby a current and a voltage can be adjusted for each electric vehicle.

In addition, NPL 1 describes phase shift control in a converter having a double active bridge (DAB) configuration as a bidirectional insulating DC/DC converter charging and discharging the electric vehicle in which reactive power is suppressed.

### CITATION LIST

### Patent Literature

PTL 1: Japanese National Patent Publication No. 2012-518987

### Non Patent Literature

NPL 1: Ryota KONDO et al., “Experimental Verification of Reducing Power Loss under Light Load Condition of a Bi-Directional Isolated DC/DC Converter for a Battery Charger-Discharger of Electric Vehicle”, Aug. 1, 2017, IEEE Transactions on Industry Applications Vol. 137 No. 8 pp. 673-680

### SUMMARY OF INVENTION

### Technical Problem

In the universal charging device described in PTL 1, as illustrated in FIG. 18, on a connection side with respect to a power system (AC), a DC/AC converter is connected between the power system and the plurality of converters (charge packs or charge modules). However, while a plurality of specifications such as a single phase of 200 V, a neutral point ground three-phase of 200 V, a V-phase ground of 200 V, and a neutral point ground of 400 V exist in the power system of a connection destination, only a simple connection relationship is described between each converter and the DC/AC converter. For this reason, when a DC voltage transferred between the DC/AC converter and the plurality of converters is different according to the specification of the power system of the connection destination, there is a concern that the specification of each converter needs to be changed. Thus, a common converter is difficult to cope with the AC power system of the connection destination, and there is a concern that expandability and versatility with respect to a difference in specifications of the power system are degraded.

The present disclosure has been made to solve the above problems, and an object of the present disclosure is to improve the extensibility and versatility of the power conversion unit and the power conversion device, used in the power conversion system between the DC power supply represented by the in-vehicle battery and the power system, with respect to the difference in specifications of the power system.

### Solution to Problem

According to one aspect of the present invention, a power conversion unit includes an input end to connect with a DC power supply, a first DC voltage end configured of a first terminal and a second terminal, a second DC voltage end configured of a third terminal and a fourth terminal, a converter, and a controller to control the converter. The converter performs DC/DC power conversion accompanied by power transmission between the input end, and the first DC voltage end and the second DC voltage end. The controller generates a control command for the converter controlling a first voltage at the first DC voltage end and a second voltage at the second DC voltage end to a voltage target value.

According to another aspect of the present invention, a power conversion device includes a plurality of the power conversion units and an output connector. The output connector interconnects a first DC voltage end and a second DC voltage end of a plurality of power conversion units using first to fourth terminals of each power conversion unit.

### Advantageous Effects of Invention

According to the present disclosure, the connection side with the power system on the opposite side to the connection side with the DC power supply can be configured using the DC voltage controlled to the voltage target value, the DC voltage being generated at both the first and second DC voltage ends by the DC/DC power conversion with the input end (DC power supply side) of the power conversion unit. As a result, the extensibility and the versatility with respect to the difference in specifications of the power system can be enhanced in the power conversion unit and the power conversion device including the plurality of power conversion units.

### BRIEF DESCRIPTION OF DRAWINGS

FIG. 1 is a circuit diagram illustrating a configuration of a power conversion unit according to a first embodiment.

FIG. 2 is an operation waveform diagram illustrating a converter at a time of control by a phase shift pattern 1A.

FIG. 3 is a conceptual diagram illustrating an operation of a phase shift amount control unit in the phase shift pattern 1A.

FIG. 4 is an operation waveform diagram illustrating the converter at the time of control by a phase shift pattern 1B.

FIG. 5 is a conceptual diagram illustrating the operation of the phase shift amount control unit in the phase shift pattern 1B.

FIG. 6 is an operation waveform diagram illustrating the converter at the time of control by a phase shift pattern 1C.

FIG. 7 is a flowchart illustrating switching stop control in the phase shift pattern 1C.

FIG. 8 is a conceptual diagram illustrating the operation of the phase shift amount control unit in the phase shift pattern 1C.

FIG. 9 is a circuit diagram illustrating a configuration of a power conversion unit according to a first modification of the first embodiment.

FIG. 10 is a circuit diagram illustrating a configuration of a power conversion unit according to a second modification of the first embodiment.

FIG. 11 is a conceptual diagram illustrating the operation of the phase shift amount control unit in a phase shift pattern 2A.

FIG. 12 is a conceptual diagram illustrating the operation of the phase shift amount control unit in a phase shift pattern 2B.

FIG. 13 is a conceptual diagram illustrating the operation of the phase shift amount control unit according to a phase shift pattern 2C.

FIG. 14 is a flowchart illustrating the switching stop control in the phase shift pattern 2C.

FIG. 15 is a circuit diagram illustrating a configuration of a power conversion unit according to a third modification of the first embodiment.

FIG. 16 is a block diagram illustrating a first configuration example of a power conversion device according to a second embodiment.

FIG. 17 is a block diagram illustrating a second configuration example of the power conversion device of the second embodiment.

FIG. 18 is a block diagram illustrating a first configuration example of a power conversion device according to a third embodiment.

FIG. 19 is a block diagram illustrating a second configuration example of the power conversion device of the third embodiment.

FIG. 20 is a block diagram illustrating a third configuration example of the power conversion device of the third embodiment.

FIG. 21 is a block diagram illustrating a fourth configuration example of the power conversion device of the third embodiment.

FIG. 22 is a circuit diagram illustrating a configuration of a power conversion unit according to a fourth embodiment.

FIG. 23 is an operation waveform diagram illustrating a converter in the power conversion unit in FIG. 22.

FIG. 24 is a conceptual diagram illustrating an operation of a phase shift amount control unit in FIG. 22.

FIG. 25 is a flowchart illustrating a control operation switching function by the controller of the power conversion unit of the fourth embodiment.

FIG. 26 is a block diagram illustrating a first configuration example of a power conversion device according to a modification of the fourth embodiment.

FIG. 27 is a block diagram illustrating a second configuration example of the power conversion device according to the modification of the fourth embodiment.

FIG. 28 is a block diagram illustrating a third configuration example of the power conversion device according to the modification of the fourth embodiment.

FIG. 29 is a block diagram illustrating a fourth configuration example of the power conversion device according to the modification of the fourth embodiment.

FIG. 30 is a schematic diagram illustrating a first configuration example of a power conversion system according to a fifth embodiment.

FIG. 31 is a schematic diagram illustrating a second configuration example of the power conversion system of the fifth embodiment.

FIG. 32 is a schematic diagram illustrating a third configuration example of the power conversion system of the fifth embodiment.

FIG. 33 is a schematic diagram illustrating a fourth configuration example of the power conversion system of the fifth embodiment.

FIG. 34 is a schematic diagram illustrating a fifth configuration example of the power conversion system of the fifth embodiment.

FIG. 35 is a circuit diagram illustrating a modification of the configuration of the converter in the power conversion unit.

### DESCRIPTION OF EMBODIMENTS

With reference to the drawings, embodiments of the present disclosure will be described in detail below. In the drawings, the same or corresponding portion is denoted by the same reference numeral, and the description will not be repeated in principle.

### First Embodiment

In a first embodiment, a configuration example and a control example of a power conversion unit serving as a basic constituent element of the power conversion device according to the first embodiment will be mainly described.

(Circuit Configuration)

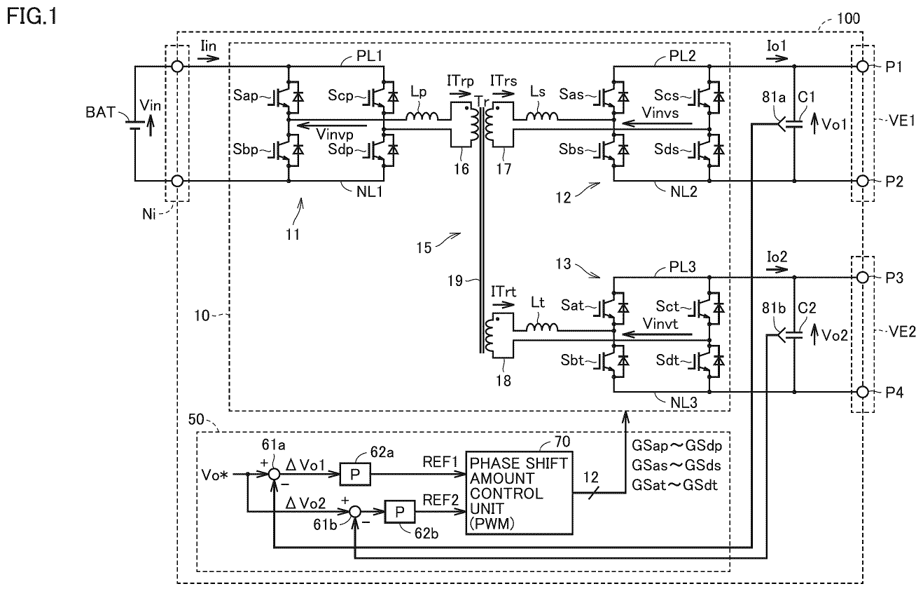

FIG. 1 is a schematic circuit diagram illustrating a power conversion unit 100 of the first embodiment.

As illustrated in FIG. 1, power conversion unit 100 includes a converter 10, a controller 50, an input end Ni to connect with a DC power supply BAT, a first DC voltage end VE1 including a first terminal P1 and a second terminal P2, a second DC voltage end VE2 including a third terminal P3 and a fourth terminal P4, a first capacitor C1, and a second capacitor C2. Converter 10 executes DC/DC power conversion between an input voltage Vin from DC power supply BAT, a first voltage Vo1 at first DC voltage end VE1, and a second voltage Vo2 at first DC voltage end VE1. First capacitor C1 and second capacitor C2 may be connected to first terminal P1 to fourth terminal P4 as external elements of power conversion unit 100.

In the first embodiment, because it is assumed that a battery, particularly, an in-vehicle secondary battery is applied as DC power supply BAT, DC power supply BAT is hereinafter also simply referred to as a battery BAT. Input end Ni can be configured of, for example, a connection port of a connector cable conforming to a charge standard of an electric vehicle such as CHAdeMO (registered trademark), and is basically used for connecting single battery BAT (DC power supply). First terminal P1 to fourth terminal P4 can be connected to an AC power system (Typically, a commercial system) through an inverter (DC/AC conversion device) as described later. That is, power conversion unit 100 can be used in a connection path between DC power supply BAT and the AC power system (not illustrated).

Converter 10 includes a first bridge 11, a second bridge 12, a third bridge 13, and a transformer 15. Transformer 15 includes a primary winding 16 and secondary windings 17, 18. Primary winding 16, secondary winding 17, and secondary winding 18 are magnetically coupled to each other through a core 19.

First bridge 11 includes semiconductor switching elements Sap, Sbp, Scp, Sdp (Sap to Sdp) connected to form full-bridge between power lines PL1. NL1 and primary winding 16. Power lines PL1, NL1 are connected to a positive electrode side and a negative electrode side of DC power supply BAT through input end Ni, respectively.

First bridge 11 converts input voltage Vin between power lines PL1, NL1 into an AC voltage Vinvp by the on and off control of semiconductor switching elements Sap to Sdp. AC voltage Vinvp is transmitted to primary winding 16 through a reactor Lp.

Hereinafter, the current from power line PL1 to first bridge 11 is also referred to as an input current Iin, and the current from first bridge 11 to primary winding 16 is also referred to as an alternating current ITrp.

Second bridge 12 includes semiconductor switching elements Sas, Sbs, Scs, Sds (Sas to Sds) connected to form full-bridge between secondary winding 17 and power lines PL2, NL2. Power lines PL2, NL2 are connected to first terminal P1 and second terminal P2, respectively. First capacitor C1 is connected between first terminal P1 (power line PL2) and second terminal P2 (power line NL2), and the high voltage side and the low voltage side of first capacitor C1 are connected to first terminal P1 and second terminal P2, respectively. A voltage detector 81a detecting first voltage Vo1 is disposed corresponding to first DC voltage end VE1 (first capacitor C1).

Second bridge 12 converts an AC voltage Vinvs into a first voltage Vo1 that is a DC voltage between power lines PL2, NL2 by the on and off control of semiconductor switching elements Sas to Sds. AC voltage Vinvs is transmitted from secondary winding 17 to second bridge 12 through a reactor Ls. Hereinafter, the current from secondary winding 17 to second bridge 12 is also referred to as an alternating current ITrs.

Similarly, third bridge 13 includes semiconductor switching elements Sat, Sbt, Set, Sdt (Sat to Sdt) connected to form full-bridge between secondary winding 18 and power lines PL3, NL3. Power lines PL3, NL3 are connected to third terminal P3 and fourth terminal P4, respectively. Second capacitor C2 is connected between third terminal P3 (power line PL3) and fourth terminal P4 (power line NL3), and the high-voltage side and the low-voltage side of second capacitor C2 are connected to third terminal P3 and fourth terminal P4, respectively. A voltage detector 81b detecting second voltage Vo2 is disposed corresponding to second DC voltage end VE2 (second capacitor C2).

Third bridge 13 converts AC voltage Vinvt into second voltage Vo2 that is the DC voltage between power lines PL3, NL3 by the on and off control of semiconductor switching elements Sat to Sdt. AC voltage Vinvt is transmitted from secondary winding 17 to second bridge 12 through a reactor Lt. Hereinafter, the current from secondary winding 18 to third bridge 13 is also referred to as an alternating current ITrt.

Each of first bridge 11 to third bridge 13 has two “legs” in parallel, each configured by two semiconductor switching elements connected in series between power lines PL1 to PL3 and power lines NL1 to NL3. Hereinafter, among the two semiconductor switching elements configuring each leg, the semiconductor switching element connected to power lines PL1 to PL3 is also referred to as an “upper arm element”, and the semiconductor switching element connected to power lines NL1 to NL3 is also referred to as a “lower arm element”.

Each of reactors Lp, Ls, Lt may be configured by connection of a reactor element, or configured by leakage inductance of each of primary winding 16 and secondary windings 17, 18.

As described above, converter 10 has the DAB configuration. Furthermore, the AC output ends of first bridge 11, second bridge 12, and third bridge 13 are electrically insulated and interconnected by transformer 15. As a result, the power transmission with insulation through transformer 15 can be performed between battery BAT (input voltage Vin) connected to input end Ni, first DC voltage end VE1 (first voltage Vo1), and second DC voltage end VE2 (second voltage Vo2). Converter 10 enables both the power transmission (BAT discharge operation) from battery BAT (DC power supply) to first DC voltage end VE1 and second DC voltage end VE2 and the power transmission (BAT charge operation) from first DC voltage end VE1 and second DC voltage end VE2 to battery BAT (DC power supply), namely, bidirectional power conversion.

Each of the semiconductor switching elements configuring first bridge 11 to third bridge 13 can be configured of, for example, an insulated gate bipolar transistor (IGBT) or a metal-oxide-semiconductor field-effect transistor (MOSFET). Hereinafter, the semiconductor switching element is also simply referred to as a “switching element”.

Controller 50 controls first voltage Vo1 and second voltage Vo2 using detection values of voltage detectors 81a, 81b. In the configuration example of FIG. 1, controller 50 controls converter 10 such that first voltage Vo1 and second voltage Vo2 approach a common voltage target value Vo*.

Specifically, controller 50 includes subtraction units 61a, 61b, gain multiplication units 62a, 62b, and a phase shift amount control unit 70. Subtraction unit 61a subtracts the detection value of voltage detector 81a from voltage target value Vo* to calculate a voltage deviation ΔVo1=Vo*−Vo1. Subtraction unit 61b calculates a voltage deviation ΔVo2=Vo*−Vo2 by subtracting the detection value of voltage detector 81b from voltage target value Vo*.

Gain multiplication unit 62a generates a command value REF1 causing first voltage Vo1 to approach voltage target value Vo* by multiplying voltage deviation ΔVo1 from subtraction unit 61a by a predetermined proportional gain. Similarly, gain multiplication unit 62b multiplies voltage deviation ΔVo2 from subtraction unit 61b by a predetermined proportional gain, thereby generating a command value REF2 causing second voltage Vo2 to approach voltage target value Vo*.

Based on command values REF1, REF2, phase shift amount control unit 70 generates gate signals GSap to GSdp controlling on and off of semiconductor switching elements Sap to Sdp (first bridge 11), gate signals GSas to GSds controlling on and off of semiconductor switching elements Sas to Sds (second bridge 12), and gate signals GSat to GSdt controlling on and off of semiconductor switching elements Sat to Sdt (third bridge 13). Command value REF1 corresponds to an example of the “first command value”, and command value REF2 corresponds to an example of the “second command value”. Voltage detector 81a corresponds to an example of the “first voltage detector”, and voltage detector 81b corresponds to an example of the “second voltage detector”.

First bridge 11 to third bridge 13 can be operated according to any known control method. However, in the first embodiment, as an example, it is assumed that controller 50 controls first voltage Vo1 and second voltage Vo2 with the power transmission by pulse width modulation (PWM) control adjusting a phase shift amount between AC voltages Vinvp, Vinvs, Vinvt generated at the AC output ends of first bridge 11, second bridge 12, and third bridge 13 as described below. Accordingly, the gate signals GSap to GSdp, GSas to GSds, GSat to GSdt are generated according to the switching pattern generating the phase shift amount calculated from command values REF1, REF2. Gate signals GSap to GSdp, GSas to GSds, GSat to GSdt correspond to an example of the “control command for the converter”.

Hereinafter, phase shift patterns 1A to 1C will be described as an example controlling the phase shift amount. In the present specification, the phase shift amount and the phase are indicated by setting the switching period of each switching element to 360°.

(Control by Phase Shift Pattern 1A)

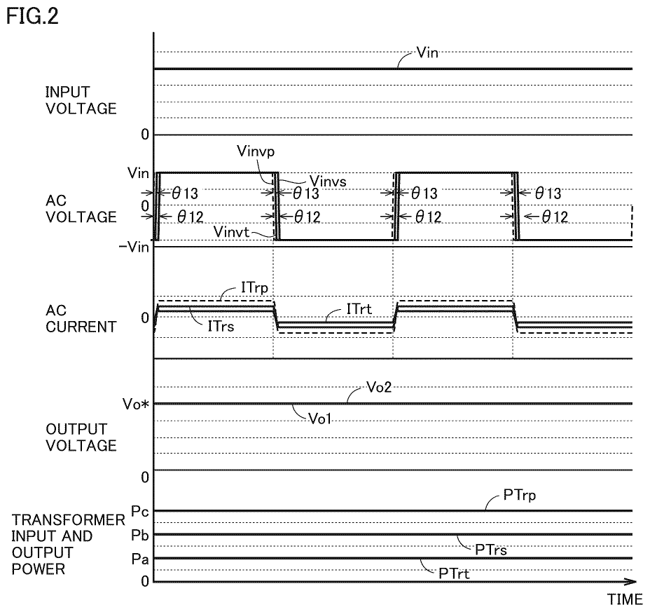

FIG. 2 illustrates an operation waveform example of converter 10 controlled according to phase shift pattern 1A that is the first control example. FIG. 2 illustrates a simulation waveform when a load of Pb [W] (not illustrated) is connected to first DC voltage end VE1 and when a load of Pa [W] (not illustrated) is connected to second DC voltage end VE2.

FIG. 2 illustrates input voltage Vin from battery BAT, AC voltage Vinvp and AC current ITrp of first bridge 11, AC voltage Vinvs and AC current ITrs of second bridge 12, AC voltage Vinvt and AC current ITrt of the third bridge, first voltage Vo1 and second voltage Vo1 as output voltages, and AC power PTrp (active power) from first bridge 11 to transformer 15, AC power PTrs (active power) from transformer 15 to second bridge 12, and AC power PTrs (active power) PTrt from transformer 15 to third bridge 13 as input and output power.

As a basic control, in each of first bridge 11 to the third bridge, the two switching elements that are connected in series and configure the same leg are alternately turned on and off for the same time length. Furthermore, in phase shift pattern 1A, the upper arm element and the lower arm element (for example, Sap and Sdp, or Sbp and Scp in the first inverter) of the adjacent leg in the same bridge are alternately turned on and off. As a result, AC voltages Vinvp, Vinvs, Vinvt indicate AC waveforms having no zero voltage period, and the periods of Vin or −Vin are 180° each.

As illustrated in FIG. 2, in phase shift pattern 1A, controller 50 controls a phase shift amount θ12 of AC voltage Vinvs of second bridge 12 with respect to AC voltage Vinvp of first bridge 11 and a phase shift amount θ13 of AC voltage Vinvt of third bridge 13 with respect to AC voltage Vinvp of first bridge 11 according to command values REF1, REF2. In the waveform example of FIG. 2, a state of θ12>θ13 (PTrs>PTrt) is illustrated.

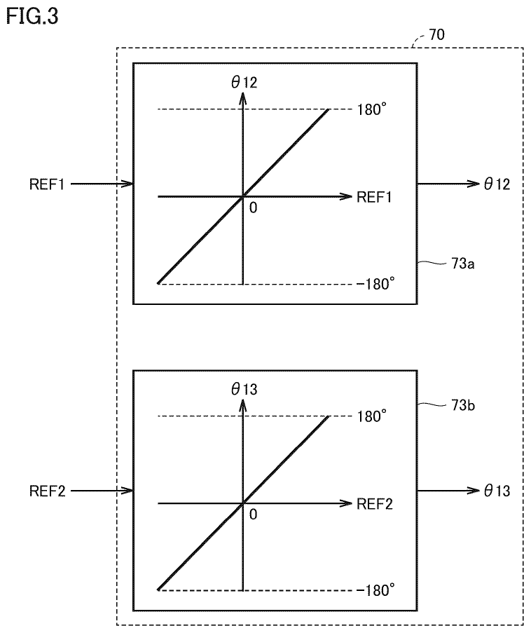

FIG. 3 is a conceptual diagram illustrating an operation of phase shift amount control unit 70 in phase shift pattern 1A.

As illustrated in FIG. 3, phase shift amount control unit 70 includes an arithmetic unit 73a that calculates phase shift amount θ12 from command value REF1 and an arithmetic unit 73b that calculates phase shift amount θ13 from command value REF2.

Phase shift amount θ12=0 indicates a state in which AC voltage Vinvp (first bridge 11) and AC voltage Vinvs (second bridge 12) are in phase, and phase shift amount θ13=0 indicates a state in which AC voltage Vinvp (first bridge 11) and AC voltage Vinvt (third bridge 13) are in phase. On the other hand, a state in which the phases of AC voltage Vinvs (second bridge 12) and AC voltage Vinvt (third bridge 13) are advanced with respect to the phase of AC voltage Vinvp (first bridge 11) is defined as θ12>0 and θ13>0.

Arithmetic unit 73a requires phase shift amount θ12 within a range of −180° to 180° from command value REF1 according to a linear function of θ12=0 when REF1=0 (that is, ΔVo1=0). Similarly, arithmetic unit 73b acquires phase shift amount θ13 within the range of −180° to 180° from command value REF1 according to a linear function of θ13=0 when REF2=0 (that is, ΔVo2=0).

Arithmetic units 73a, 73b may be configured to execute numerical arithmetic operation according to the linear function in FIG. 3, and configured as a lookup table setting phase shift amounts θ12, θ13 from command values REF1, REF2 according to a correspondence relationship by the linear function.

Furthermore, phase shift amount control unit 70 generates gate signals GSat to GSdt turning on and off switching elements Sap to Sdp of first bridge 11, switching elements Sas to Sds of second bridge 12, and switching elements Sat to Sdt of third bridge 13 so as to implement calculated phase shift amounts θ12, θ13.

With reference again to FIG. 2, converter 10 controls first voltage Vo1 and second voltage Vo2 that are output voltages to Vo* under the condition that AC power PTrs=Pb [W], namely, Pb [W] is output from first DC voltage end VE1 (first and second terminals P1, P2) to the load and AC power PTrt=Pa [W], namely, Pa [W] is output from second DC voltage end VE2 (third and fourth terminals P3, P4) to the load. At this time, DC power corresponding to AC power PTrp=Pc [W] (Pc=Pa+Pb) is input from battery BAT to converter 10 (first bridge 11).

As described above, it is understood that the power transmission operation of converter 10 in which first voltage Vo1 and second voltage Vo2 are controlled according to the voltage target value under the condition that the power supplied to first DC voltage end VE1 and the power supplied to second DC voltage end VE2 are different from each other by the control according to phase shift pattern 1A is established.

(Control by Phase Shift Pattern 1B)

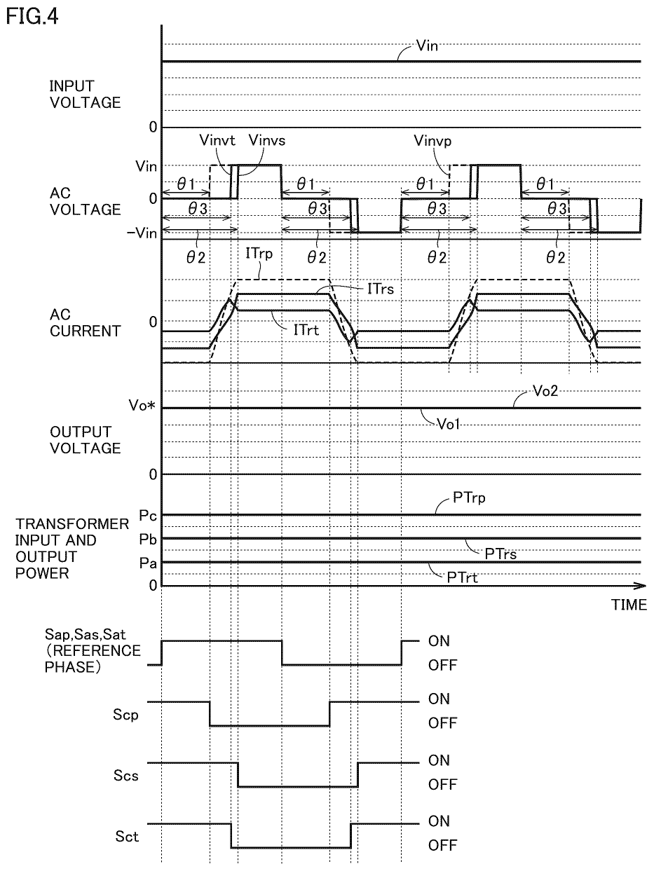

FIG. 4 illustrates an operation waveform example of converter 10 controlled according to phase shift pattern 1B that is the second control example. Similarly to FIG. 2, FIG. 4 also illustrates the simulation waveform when the load of Pb [W] (not illustrated) is connected to first DC voltage end VE1 and when the load of Pa [W] (not illustrated) is connected to second DC voltage end VE2.

Similarly to FIG. 2, input voltage Vin, AC voltages Vinvp, Vinvs, Vinvt, AC currents ITrp, ITrs, ITrt, first voltage Vo1 and second voltage Vo2 as the output voltages, and AC powers PTrp, PTrs, PTrt as the input and output powers of transformer 15 are also illustrated in FIG. 4.

As illustrated in FIG. 4, in phase shift pattern 1B, switching element Sap of first bridge 11 is turned on and off in the reference phase according to the switching cycle.

On the other hand, on and off timing of switching element Scp of first bridge 11 is controlled so as to have a phase shift amount θ1 with respect to the on and off timing (reference phase) of switching element Sap. Switching element Sbp is alternately turned on and off with switching element Sap of the same leg, and switching element Sdp is alternately turned on and off with switching element Scp of the same leg. As a result, the zero voltage period according to phase shift amount θ1 is generated in AC voltage Vinvp of first bridge 11. That is, each period during which AC voltage Vinvp becomes Vin or −Vin is (180-θ1)°.

In second bridge 12, switching element Sas is turned on and off in the same phase as the on and off timing (reference phase) of switching element Sap of first bridge 11, while switching element Scs is turned on and off so as to have a phase shift amount θ2 with respect to the reference phase. Switching elements Sbs, Sds are alternately turned on and off with switching elements Sas, Scs of the same leg. As a result, the zero voltage period according to phase shift amount θ2 is generated in AC voltage Vinvs of second bridge 12. That is, each period during which AC voltage Vinvs becomes Vin or −Vin is (180-θ2)°.

In third bridge 13, switching element Sat is turned on and off in the same phase as the on and off timing (reference phase) of switching element Sap of first bridge 11, while switching element Sct is turned on and off so as to have a phase shift amount θ3 with respect to the reference phase. Switching elements Sbt, Sdt are alternately turned on and off with switching elements Sat, Sct of the same leg. As a result, the zero voltage period according to phase shift amount θ3 is generated in AC voltage Vinvt of third bridge 13. That is, each period during which AC voltage Vinvt becomes Vin or −Vin is (180-θ3°).

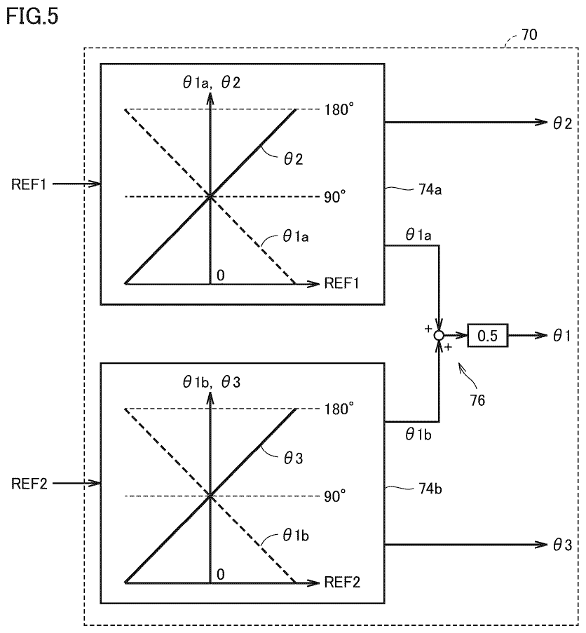

FIG. 5 is a conceptual diagram illustrating the operation of phase shift amount control unit 70 in phase shift pattern 1B.

As illustrated in FIG. 5, phase shift amount control unit 70 includes an arithmetic unit 74a that calculates phase shift amounts θ1a, θ2 from command value REF1, an arithmetic unit 74b that calculates phase shift amounts θ1b, θ3 from command value REF2, and an average value calculation unit 76.

Arithmetic unit 74a acquires phase shift amounts θ1a, θ2 within the range of −180° to 180° from command value REF1 according to the linear function of 02=90° when REF1=0 (that is, ΔVo1=0) and the linear function of θ1a=180°-θ2.

Arithmetic unit 74b obtains phase shift amounts θ1b, θ3 within the range of −180° to 180° from command value REF2 according to the linear function of 03=90° when REF2=0 (that is, ΔVo2=0) and the linear function of θ1b=180°-θ3.

Average value calculation unit 76 outputs an average value of phase shift amount θ1a from arithmetic unit 74a and phase shift amount θ1b from arithmetic unit 74b as phase shift amount θ1. Arithmetic units 74a, 74b can also be configured as a numerical calculator or a lookup table according to the linear function in FIG. 4.

Furthermore, phase shift amount control unit 70 generates gate signals GSap to GSdp, GSas to GSds, GSat to GSdt turning on and off switching elements Sap to Sdp of first bridge 11, switching elements Sas to Sds of second bridge 12, and switching elements Sat to Sdt of third bridge 13 so as to implement phase shift amounts θ1 to 03 calculated in FIG. 5.

With reference again to FIG. 4, in converter 10, first voltage Vo1 and second voltage Vo2 that are the output voltages can be controlled to voltage target value Vo* under AC power PTrs=Pb [W] and AC power PTrt=Pa [W] by the control according to phase shift pattern 1B. That is, it is understood that the power transmission operation of converter 10 in which first voltage Vo1 and second voltage Vo2 are controlled according to the voltage target value under the condition that power Pb [W] supplied to first DC voltage end VE1 and power Pa [W] supplied to second DC voltage end VE2 are different from each other also by the control according to phase shift pattern 1B is established.

In FIG. 4 (phase shift pattern 1B), the zero voltage periods of AC voltages Vinvp, Vinvs, Vinvt applied to transformer 15 are larger than those in FIG. 2 (phase shift pattern 1A). For this reason, efficiency of the power transmission can be enhanced by an effect of reducing an iron loss due to a decrease in magnetic flux density generated in transformer 15.

(Control by Phase Shift Pattern 1C)

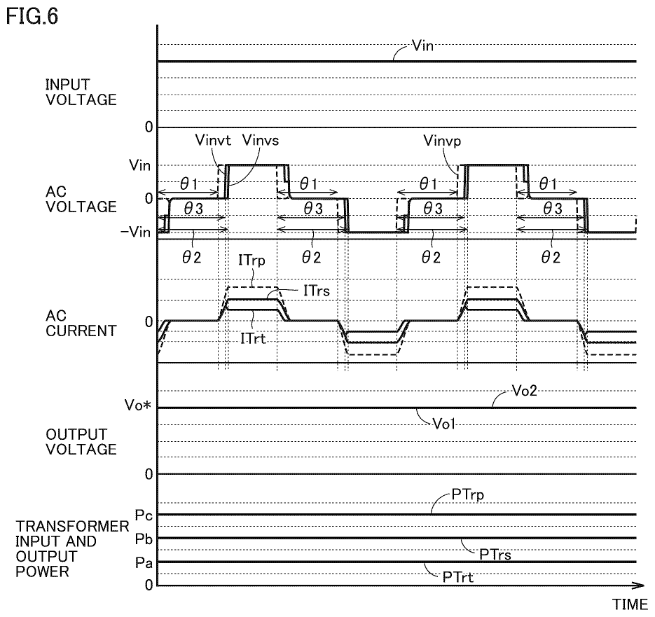

FIG. 6 illustrates an operation waveform example of converter 10 controlled according to phase shift pattern 1C that is the third control example. Similarly to FIGS. 2 and 4, FIG. 6 also illustrates a simulation waveform when the load (not illustrated) of Pb [W] is connected to first DC voltage end VE1 and when the load (not illustrated) of Pa [W] is connected to second DC voltage end VE2.

Similar to FIGS. 2 and 4, input voltage Vin, AC voltages Vinvp, Vinvs, Vinvt, AC currents ITrp, ITrs, ITrt, first voltage Vo1 and second voltage Vo1 as the output voltages, and AC powers PTrp, PTrs, PTrt as the input and output power of transformer are also illustrated in FIG. 6.

Also in phase shift pattern 1C, similarly to phase shift pattern 1B, the on and off timings (phases) of the switching elements Scp, Sdt of first bridge 11, switching elements Scs, Sds of second bridge 12, and switching elements Sct, Sdt of third bridge 13 are controlled so as to adjust phase shift amounts θ1 to θ3 with respect to the reference phase.

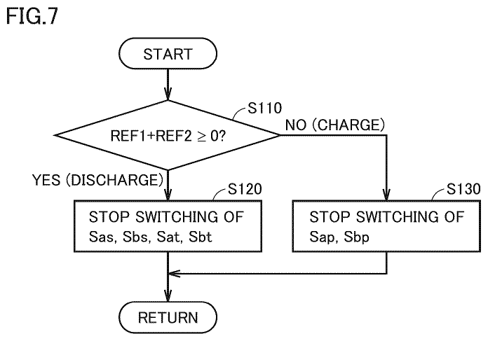

Furthermore, in phase shift pattern 1C, the on and off (switching) of some switching elements is stopped by switching stop control described with reference to FIG. 7.

As illustrated in the flowchart of FIG. 7, phase shift amount control unit 70 selects a switching element in which switching is stopped according to whether converter 10 performs the discharge operation or the charge operation of battery BAT (DC power supply) from command values REF1, REF2.

Specifically, in step (hereinafter, simply referred to as “5”) 110, phase shift amount control unit 70 determines whether REF1+REF2≥0. Then, when REF1+REF2≥0 (YES in S110), namely, during the discharge operation of battery BAT in which power is transmitted from first bridge 11 to second bridge 12 and third bridge 13, phase shift amount control unit 70 fixes switching elements Sas, Sbs and Sat, Sbt configuring the legs on the left side (reference phase side) of second bridge 12 and third bridge 13 on the power receiving side to off in S120.

On the other hand, when REF1+REF2<0 (NO in S110), namely, during the charging operation of battery BAT in which power is transmitted from second bridge 12 and third bridge 13 to first bridge 11, phase shift amount control unit 70 fixes switching elements Sap, Sbp configuring the leg on the left side (reference phase side) of first bridge 11 on the power receiving side to off in S130.

As described above, in phase shift pattern 1C, in first bridge 11 or second bridge 12 and third bridge 13, the switching elements configuring the leg on the left side (reference phase side) are fixed to off (switching is stopped). Then, the switching elements configuring the right legs of first bridge 11 to third bridge 13 are turned on and off according to phase shift amounts θ1 to θ3, whereby AC voltages Vinvp, Vinvs, Vinvt in FIG. 6 are generated.

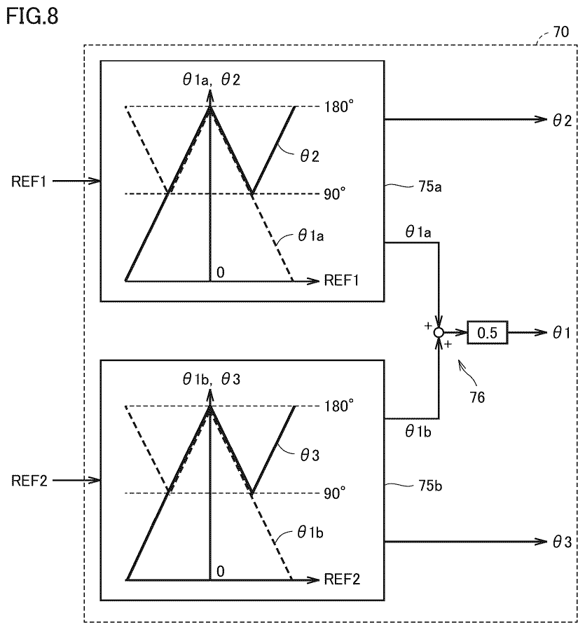

FIG. 8 is a conceptual diagram illustrating the operation of phase shift amount control unit 70 in phase shift pattern 1C.

As illustrated in FIG. 8, phase shift amount control unit 70 includes an arithmetic unit 75a that calculates phase shift amounts θ1a, θ2 from command value REF1, an arithmetic unit 75b that calculates phase shift amounts θ1b, θ3 from command value REF2, and an average value calculation unit 76.

Arithmetic unit 75a calculates phase shift amounts θ1a, θ2 from command value REF1, and arithmetic unit 75h calculates phase shift amounts θ1b, θ3 from command value REF2.

In arithmetic unit 75a, phase shift amount θ2 is set according to a characteristic of an illustrated polygonal line shape (solid line). Specifically, in the region of REF1>0, phase shift amount θ2 is set within the range of 90° to 180°. Specifically, when REF1=0.02=180° is set, and θ2 is set to decrease at a constant rate toward 90° as REF1 increases. Furthermore, in the region where REF1 is larger than the value of REF1 at which 02=90°, θ2 is set to increase at a constant rate up to 180° as |REF1| increases. Furthermore, in the region of REF1<0, phase shift amount θ2 is set to decrease at a constant rate toward 0° as |REF1| increases.

On the other hand, phase shift amount θ1a is set according to a characteristic of an illustrated polygonal line shape (dotted line). Specifically, in the region of REF1≥0, phase shift amount θ1a is set so as to decrease at a constant rate toward 0° as REF1 increases. Furthermore, in the region of REF1<0, when REF1=0, θ1a=180° is set, and θ1a is set to decrease at a constant rate toward 90° as |REF| increases. Furthermore, in the region where |REF1| is larger than the value of REF1 at which θ1a=90°, θ1a is set to increase at a constant rate up to 180° as |REF1| increases. In arithmetic unit 75b, as illustrated in FIG. 8, phase shift amounts θ1b, θ3 are set for command value REF2 according to the same characteristics as phase shift amounts θ1a, θ2 for command value REF1 in arithmetic unit 75a.

Average value calculation unit 76 outputs an average value of phase shift amount θ1a from arithmetic unit 75a and phase shift amount θ1b from arithmetic unit 75b as phase shift amount θ1. Arithmetic units 75a, 75b can also be configured as a numerical calculator or a lookup table according to the characteristic of the polygonal line graph in FIG. 8.

Furthermore, phase shift amount control unit 70 generates gate signals GSap to GSdp, GSas to GSds, GSat to GSdt turning on and off switching elements Sap to Sdp of first bridge 11, switching elements Sas to Sds of second bridge 12, and switching elements Sat to Sdt of third bridge 13 such that the switching stop control in FIG. 7 and phase shift amounts θ1 to θ3 calculated in FIG. 8 are implemented.

With reference again to FIG. 6, in converter 10, output voltages Vo1, Vo1 can be controlled to voltage target value Vo* under AC power PTrs=Pb [W] and AC power PTrt=Pa [W] by the control according to phase shift pattern 1C. That is, it is understood that the power transmission operation of converter 10 in which first voltage Vo1 and second voltage Vo2 are controlled according to the voltage target value under the condition that power Pb [W] supplied to first DC voltage end VE1 and power Pa [W] supplied to second DC voltage end VE2 are different from each other also by the control according to phase shift pattern 1C is established.

In FIG. 6 (phase shift pattern 1C), zero current period is provided in AC currents ITrp, ITrs, ITrt that are input to and output from transformer 15. For this reason, as described in NPL 1, the power loss can be reduced by reducing AC reactive power according to a switching frequency. In addition, heat generation due to magnetic saturation in transformer 15 can be prevented by preventing generation of DC polarization of transformer 15.

As described above, according to power conversion unit 100 including converter 10 having the DAB configuration in FIG. 1, the output voltage (first voltage Vo1 and second voltage Vo2) is controlled to the target voltage by the DC/DC power conversion using second bridge 12 and third bridge 13 connected through transformer with respect to first bridge 11 connected to the DC power supply (battery BAT), and the power transmission can be performed bidirectionally between the DC power supply (battery BAT) of input voltage Vin, and first DC voltage end VE1 and second DC voltage end VE2 on the load side. Thus, the configuration of power conversion unit 100 having high versatility and extensibility in application to the configuration connecting the DC power supply and the power system can be implemented as will be described later.

As described above, input end Ni is used for connection of single battery BAT (DC power supply), so that the device can be downsized as compared with a universal charging device described in PTL 1. Specifically, in PTL 1, because one converter (charge pack or charge module) is connected to a plurality of electric vehicles (in-vehicle batteries) by a mesh unit, there is a concern that it is difficult to switch the distribution destination of the current after the charge is started once. For example, in the case where the output current of the converter is constant before and after the distribution switching, the power changes suddenly when the battery voltages of the electric vehicle before and after the switching are different from each other. In order to prevent a voltage fluctuation accompanying this, it is necessary to increase the capacitances of capacitors connected respectively to the input side and the output side of the converter. On the other hand, in power conversion unit 100 having input end Ni to which single battery BAT (DC power supply) is connected, the capacitances of first capacitor C1 and second capacitor C2 can be restrained.

### First Modification of First Embodiment

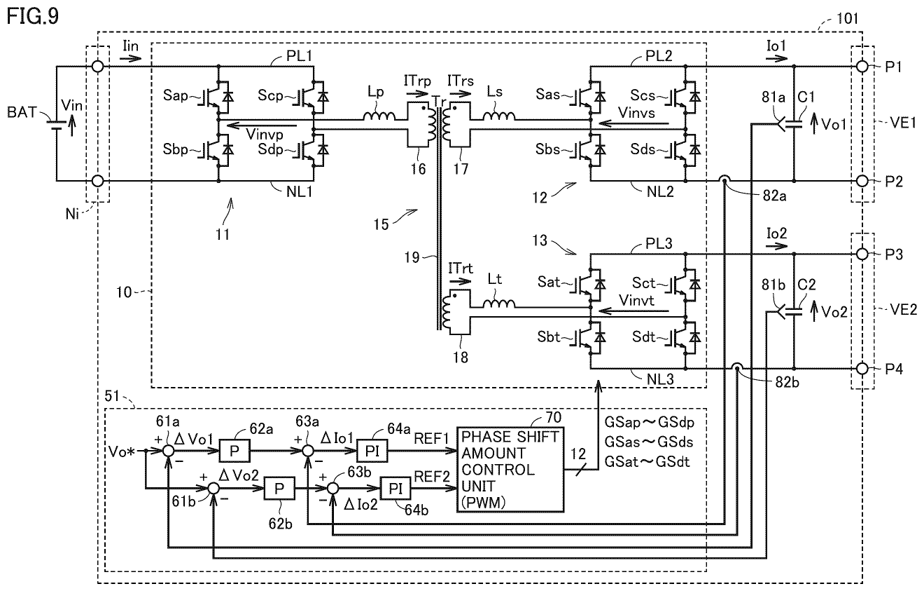

FIG. 9 is a circuit diagram illustrating a configuration of a power conversion unit 101 according to a first modification of the first embodiment.

As illustrated in FIG. 9, power conversion unit 101 of the first modification of the first embodiment is different from power conversion unit 100 (FIG. 1) of the first embodiment in that a controller 51 is included instead of controller 50. Converter 10 has the DAB configuration similar to that of FIG. 1.

In power conversion unit 101, current detectors 82a, 82b that detect the output currents (first current Io1 and second current I02) are further disposed in addition to voltage detectors 81a. 81b that detect the output voltages (first voltage Vo1 and second voltage Vo2). First current Io1 is a current supplied from second bridge 12 to the load (not illustrated) connected to first DC voltage end VE1. Similarly, second current Io2 is a current supplied from third bridge 13 to the load (not illustrated) connected to second DC voltage end VE2. That is, during the charging operation of battery BAT, first current Io1 and second current Io2 have negative values.

Controller 51 controls the output voltage (first voltage Vo1 and second voltage Vo2) to voltage target value Vo* using the detection values of both the output voltage (first voltage Vo1 and second voltage Vo2) and the output current (first current Io1 and second current Io2). Current detector 82a corresponds to an example of the “first current detector”, and current detector 82b corresponds to an example of the “second current detector”.

Controller 51 further includes subtraction units 63a, 63b and gain arithmetic units 64a, 64b in addition to subtraction units 61a, 61b and gain multiplication units 62a, 62b similar to controller 50 (FIG. 1). In controller 51, the output values (a product of voltage deviations ΔVo1, ΔVo2 and a proportional gain) of gain multiplication units 62a, 62b are positioned as target values of the output currents (first current Io1 and second current I02).

Subtraction unit 63a subtracts the detection value of current detector 82a from the output value of gain multiplication unit 62a to calculate a current deviation ΔIo1 of first current Io1 with respect to the target value. Similarly, subtraction unit 63b subtracts the detection value of current detector 82b from the output value of gain multiplication unit 62b to calculate a current deviation ΔIo2 of second current Io2 with respect to the target value. Gain arithmetic unit 64a generates command value REF1 by proportional integral (PI) control for current deviation ΔIo1. Gain arithmetic unit 64b generates command value REF2 by proportional integral (PI) control for current deviation ΔIo2.

Controller 51 further includes phase shift amount control unit 70 that receives command values REF1, REF2. Phase shift amount control unit 70 generates gate signals GSap to GSdp, GSas to GSds, GSat to GSdt so as to control the phase shift amount between first bridge 11 and second bridge 12 and third bridge 13 according to any one of phase shift patterns 1A to 1C described in the first embodiment.

Thus, the same power transmission operation and output voltage (first voltage Vo1 and second voltage Vo2) control as those of power conversion unit 100 can be executed also in power conversion unit 101 of the first modification of the first embodiment. Furthermore, the control that avoids large changes in the output currents (first current Io1 and second current Io2) is implemented in power conversion unit 101.

In controllers 51, 52 described in the first embodiment and the first modification thereof, first voltage Vo1 and second voltage Vo2 are controlled by common voltage target value Vo*, but voltage target value Vo can be individually set between first voltage Vo1 and second voltage Vo2.

Second modification of first embodiment.

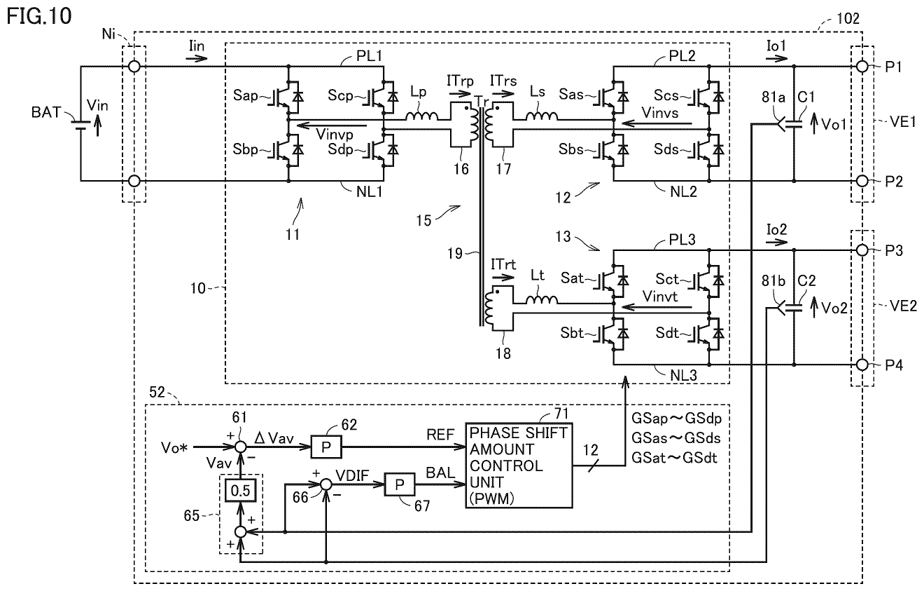

FIG. 10 is a circuit diagram illustrating a configuration of a power conversion unit 102 according to a second modification of the first embodiment.

As illustrated in FIG. 10, power conversion unit 102 of the second modification of the first embodiment is different from power conversion unit 100 (FIG. 1) of the first embodiment in that a controller 52 is included instead of controller 50. Converter 10 has the DAB configuration similar to that of FIG. 1.

Similarly to controller 50, controller 52 controls the output voltages (first voltage Vo1 and second voltage Vo2) to voltage target value Vo* using the detection values of voltage detectors 81a, 82a, but the control content is different from that of controller 50.

Controller 52 includes subtraction units 61, 66, gain multiplication units 62, 67, an average value calculation unit 65, and a phase shift amount control unit 71. Average value calculation unit 65 calculates an average voltage Vav (Vav=(Vo1+Vo2)/2) obtained by averaging the detection value of voltage detector 81a and the detection value of voltage detector 81b. Subtraction unit 61 calculates voltage deviation ΔV by subtracting average voltage Vav from voltage target value Vo*. Subtraction unit 66 calculates a voltage difference VDIF (VDIF=Vo1−Vo2) between first voltage Vo1 and second voltage Vo2.

Gain multiplication unit 62 generates command value REF causing average voltage Vav to approach voltage target value Vo* by multiplying voltage deviation ΔV from subtraction unit 61 by a predetermined proportional gain.

Gain multiplication unit 67 multiplies voltage difference VDIF from subtraction unit 66 by a predetermined proportional gain to generate a command value BAL bringing voltage difference VDIF close to zero, namely, balancing first voltage Vo1 and second voltage Vo2.

Phase shift amount control unit 71 generates gate signals GSap to GSdp, GSas to GSdsp, GSat to GSdt described in the first embodiment based on command values REF, BAL. Also in power conversion unit 102, first bridge 11 to third bridge 13 can be operated according to any known control method. For example, power conversion unit 102 can be controlled similarly to power conversion unit 100 by adjusting the phase shift amount similarly to each of phase shift patterns 1A to 1C described in the first embodiment. Command value REF corresponds to an example of the “first command value”, and command value BAL corresponds to an example of the “second command value”.

FIG. 11 is a conceptual diagram illustrating the operation of the phase shift amount control unit in a phase shift pattern 2A that controls the phase shift amount similarly to phase shift pattern 1A.

As illustrated in FIG. 11, phase shift amount control unit 71 includes an arithmetic unit 73 and subtraction units 77, 78. Arithmetic unit 73 calculates phase shift amount θ from command value REF according to a linear function similar to arithmetic units 73a, 73b in FIG. 3. Subtraction unit 77 calculates phase shift amount θ12 by subtracting command value BAL from a phase shift amount θ calculated arithmetic unit 73. Similarly, subtraction unit 78 calculates phase shift amount θ13 by subtracting command value BAL from phase shift amount θ calculated by arithmetic unit 73.

Also in phase shift pattern 2A, the definitions of the phase shift amounts θ12, θ13 are the same as those of phase shift pattern 1A (FIG. 2). Phase shift amount control unit 71 further generates gate signals GSap to GSdp, GSas to GSds, GSat to GSdt turning on and off switching elements Sap to Sdp of first bridge 11, switching elements Sas to Sds of second bridge 12, and switching elements Sat to Sdt of third bridge 13 so as to implement phase shift amounts θ12, θ13 calculated in FIG. 11.

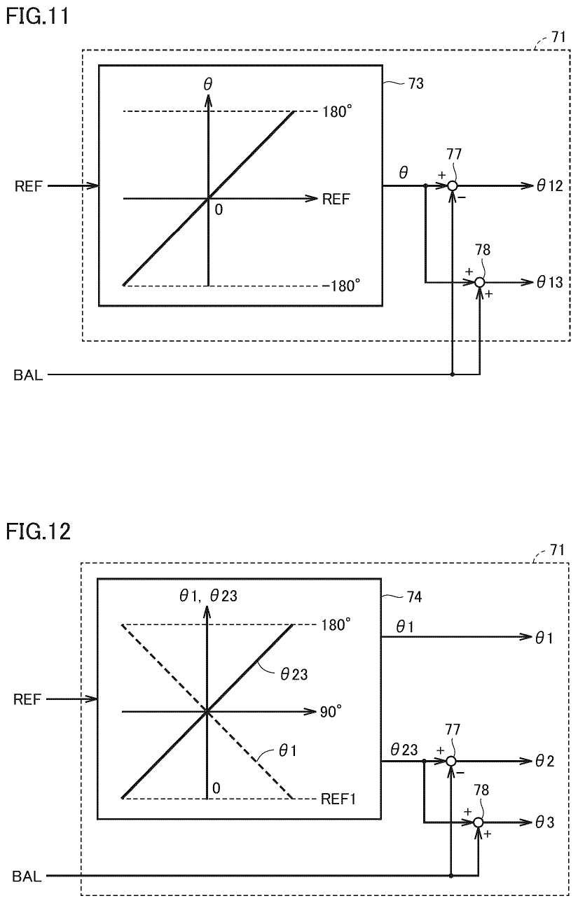

FIG. 12 is a conceptual diagram illustrating the operation of the phase shift amount control unit in a phase shift pattern 2B that controls the phase shift amount similarly to phase shift pattern 1B.

As illustrated in FIG. 12, phase shift amount control unit 71 includes an arithmetic unit 74 and subtraction units 77, 78. Arithmetic unit 74 calculates a phase shift amount θ23 from command value REF according to the characteristic similar to the linear function calculating phase shift amounts θ2, θ3 in arithmetic units 74a, 74b of FIG. 5. Furthermore, arithmetic unit 74 calculates phase shift amount 91 from command value REF according to the characteristic similar to the linear function calculating phase shift amounts θ1a, θ1b in arithmetic units 74a, 74b (FIG. 5).

Subtraction unit 77 calculates phase shift amount θ2 by subtracting command value BAL from phase shift amount θ23 calculated by arithmetic unit 74. Similarly, subtraction unit 78 calculates phase shift amount θ3 by subtracting command value BAL from phase shift amount θ23 calculated by arithmetic unit 74.

Also in phase shift pattern 2B, the definitions of phase shift amounts θ1 to θ3 are the same as those of phase shift pattern 2A (FIG. 4). Phase shift amount control unit 71 further generates gate signals GSap to GSdp, GSas to GSds, GSat to GSdt turning on and off switching elements Sap to Sdp of first bridge 11, switching elements Sas to Sds of second bridge 12, and switching elements Sat to Sdt of third bridge 13 so as to implement phase shift amounts θ1 to θ3 calculated in FIG. 12.

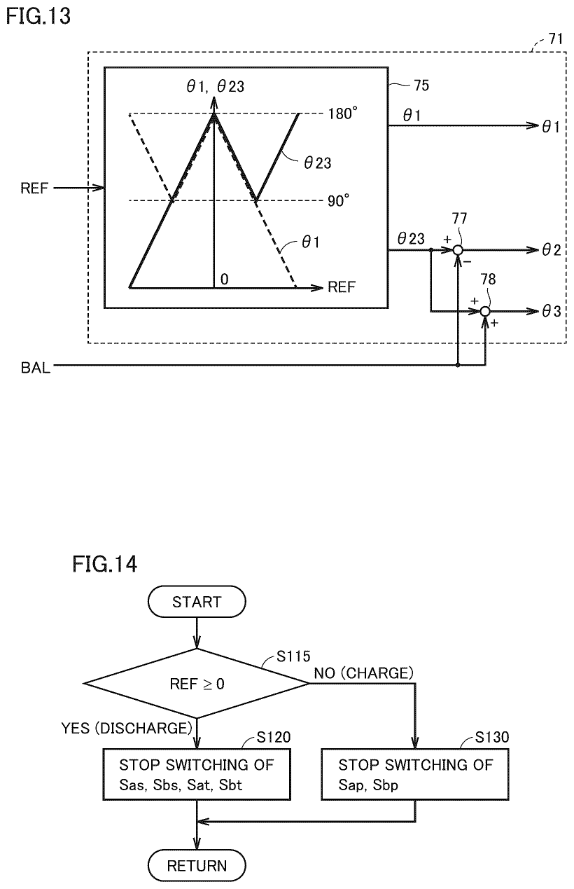

FIG. 13 is a conceptual diagram illustrating the operation of the phase shift amount control unit in a phase shift pattern 2C that controls the phase shift amount similarly to phase shift pattern 1C.

As illustrated in FIG. 13, phase shift amount control unit 71 includes an arithmetic unit 75 and subtraction units 77, 78. Arithmetic unit 75 calculates phase shift amount θ23 from command value REF according to the same characteristic (solid line) as the polygonal line shape calculating phase shift amounts θ2, θ3 in arithmetic units 75a, 75b of FIG. 8. Furthermore, arithmetic unit 75 calculates phase shift amount θ1 from command value REF according to characteristics (dotted lines) similar to the polygonal line shape calculating phase shift amounts θ1a, θ1b in arithmetic units 75a, 75b (FIG. 8).

Subtraction unit 77 calculates phase shift amount θ2 by subtracting command value BAL from phase shift amount θ23 calculated by arithmetic unit 75. Similarly, subtraction unit 78 calculates phase shift amount θ3 by subtracting command value BAL from phase shift amount θ23 calculated by arithmetic unit 75.

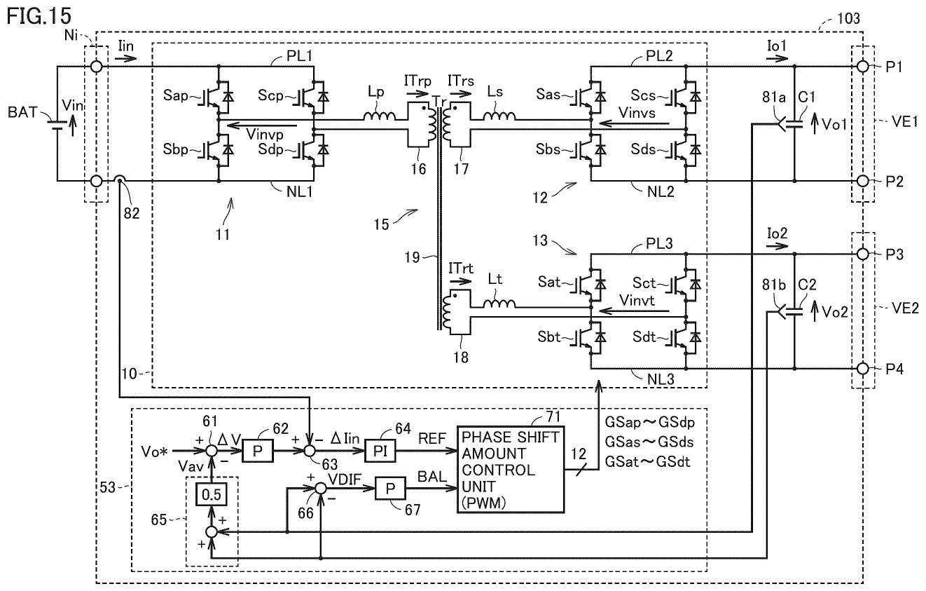

FIG. 14 is a flowchart illustrating the switching stop control in phase shift pattern 2C. As understood from the comparison between FIGS. 14 and 7, in phase shift pattern 2C, phase shift amount control unit 71 determines whether converter 10 performs the discharge operation or the charge operation of battery BAT based on command value REF in S105. When REF>0 (YES in S105), it is determined that battery BAT is in the discharge operation, and switching elements Sas, Sbs and Sat, Sbt configuring the legs on the left side (reference phase side) of second bridge 12 and third bridge 13 are fixed to off by S120 similar to FIG. 7.

On the other hand, when REF<0 (NO in S105), it is determined that battery BAT is in the charge operation, and switching elements Sap, Sbp configuring the leg on the left side (reference phase side) of first bridge 11 are fixed to off by S130 similar to FIG. 7.

Also in phase shift pattern 2C, the definitions of phase shift amounts θ1 to θ3 are the same as those of phase shift pattern 2C (FIG. 6). Phase shift amount control unit 71 further generates GSap to GSdp, GSas to GSds. GSat to GSdt for switching control of first bridge 11, second bridge 12, and third bridge 13 such that the switching stop control in FIG. 14 and the phase shift amounts θ1 to θ3 calculated in FIG. 13 are implemented.

As described above, also in power conversion unit 102 of the second modification of the first embodiment, the power transmission operation and the output voltage (first voltage Vo1 and second voltage Vo2) control of power conversion unit 100 can be executed by phase shift patterns 2A to 2C similar to phase shift patterns IA to 1C described in the first embodiment.

Third modification of first embodiment.

FIG. 15 is a circuit diagram illustrating a configuration of a power conversion unit 103 according to a third modification of the first embodiment.

As illustrated in FIG. 15, power conversion unit 103 of the third modification of the first embodiment is different from power conversion unit 102 (FIG. 10) of the first modification of the first embodiment in that a controller 53 is included instead of controller 52. Converter 10 has the DAB configuration similar to that of FIG. 1.

In power conversion unit 103, a current detector 82 that detects the input current Iin is further disposed in addition to the voltage detectors 81a, 81b that detect the output voltages (first voltage Vo1 and second voltage Vo2). Input current Iin is a current supplied from battery BAT (DC power supply) to first bridge 11. Current detector 82 corresponds to an embodiment of the “input current detector”.

Controller 53 further includes a subtraction unit 63 and a gain arithmetic unit 64 in addition to subtraction units 61, 66 and gain multiplication units 62, 67 similar to controller 52 (FIG. 10). In controller 53, the output value (the product of voltage deviation ΔV and proportional gain) of gain multiplication unit 62 is positioned as the target value of input current Iin.

Subtraction unit 63 subtracts the detection value of current detector 82 from the output value of gain multiplication unit 62 to calculate a current deviation ΔIin of input current Iin with respect to the target value. Gain arithmetic unit 64 generates command value REF by proportional integral (PI) control for current deviation ΔIin On the other hand, command value BAL bringing voltage difference VDIF close to zero is obtained by subtraction unit 66 and gain multiplication unit 67 similarly to controller 52.

Controller 53 further includes a phase shift amount control unit 71 that receives command values REF, BAL. Phase shift amount control unit 71 generates gate signals GSap to GSdp, GSas to GSds, GSat to GSdt so as to control the phase shift amount between first bridge 11 and second bridge 12 and third bridge 13 according to any one of phase shift patterns 2A to 2C described in the second modification of the first embodiment.

As a result, also in power conversion unit 103 of the third modification of the first embodiment, the same power transmission operation and output voltage (first voltage Vo1 and second voltage Vo2) control as those of power conversion unit 100 can be executed. Furthermore, in power conversion unit 103, control that avoids a large change in input current Iin is implemented.

### Second Embodiment

In a second embodiment, a configuration of a power conversion device using the power conversion unit according to the first embodiment and the modifications thereof will be described.

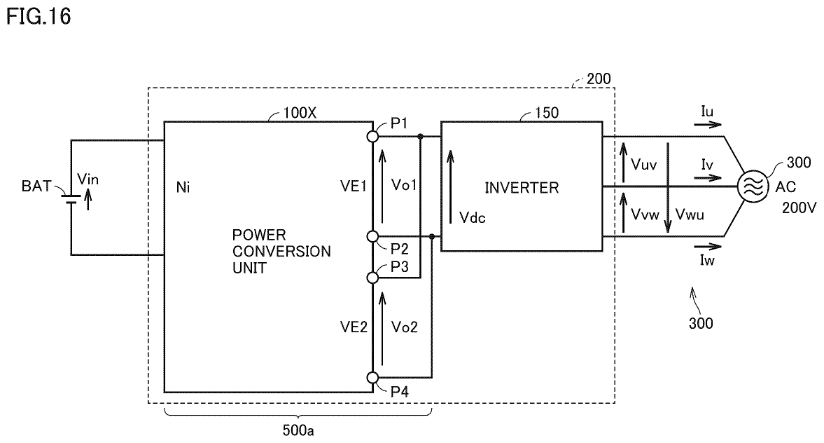

FIG. 16 illustrates a first configuration example of the power conversion device according to the first configuration example of the second embodiment.

As illustrated in FIG. 16, a power conversion system 200 is connected between a DC power supply (battery BAT) and an AC power system 300. Power conversion system 200 includes a power conversion device 500a of the first configuration example of the second embodiment and an inverter (DC/AC converter) 150. Power conversion device 500a corresponds to a DC/DC converter configured to include power conversion unit 100X of the first embodiment and the modifications thereof. Power conversion unit 100X includes power conversion unit 100 to 103 of the first embodiment and the modifications thereof.

Power conversion device 500a executes DC/DC power conversion accompanied by bidirectional power transmission between an input voltage Vin of the DC power supply (battery BAT) and a DC-side voltage Vdc of an inverter 150. Inverter 150 performs DC/AC power conversion accompanied by the bidirectional power transmission between DC-side voltage Vdc and three-phase voltages Vuv, Vvw, Vwu of AC power system 300.

Power conversion device 500a includes one power conversion unit 100X in which first DC voltage end VE1 (first and second terminals P1, P2) and second DC voltage end VE2 (third and fourth terminals P3, P4) are connected in parallel.

In power conversion unit 100X, as described in the first embodiment and the modifications thereof, first voltage Vo1 and second voltage Vo1 are controlled to voltage target value Vo*. Accordingly, power conversion device 500a can control DC-side voltage Vdc of inverter 150 to be equivalent to voltage target value Vo*.

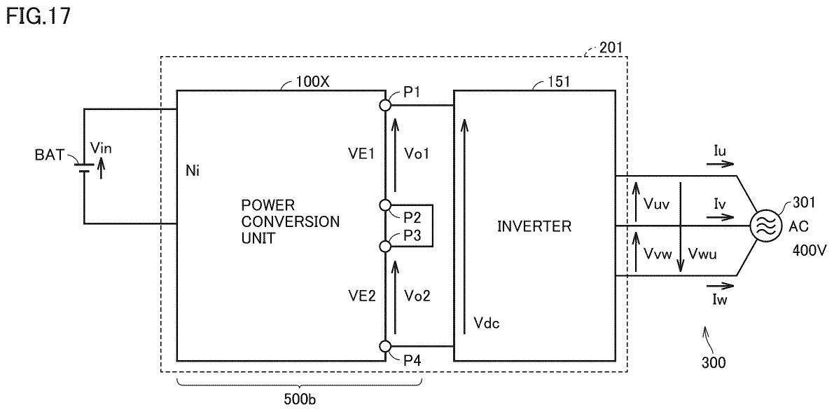

FIG. 17 illustrates a second configuration example of the power conversion device of the second embodiment.

As illustrated in FIG. 17, a power conversion system 201 is connected between battery BAT (DC power supply) and an AC power system 301. Power conversion system 201 includes a power conversion device 500b according to a second configuration example of the second embodiment and an inverter (DC/AC converter) 151.

Power conversion device 500a is different from power conversion device 500b in that first DC voltage end VE1 (first and second terminals P1, P2) and second DC voltage end VE2 (third and fourth terminals P3, P4) of one power conversion unit 100X are connected in series.

Accordingly, when controlled to Vo1=Vo2=Vo* in power conversion unit 100X, DC side voltage Vdc of an inverter 151 is controlled to be equivalent to twice voltage target value Vo*. That is, in power conversion unit 100X, by changing the connection of first terminal P1 to fourth terminal P4, the input voltage (DC) to the DC load such as the inverter having different voltage ratings can be adjusted in two stages of the voltage of 1 time voltage target value Vo* and the voltage of 2 times voltage target value Vo*.

Here, AC power system 300 in FIG. 16 is a power system of AC 200 (V) (effective value), and inverter 150 has a rating converting Vdc of DC 400 (V) into a three-phase AC voltage of AC 200 (V) (effective value). On the other hand, AC power system 301 in FIG. 17 is a power system of AC 400 (V) (effective value), and inverter 151 has a rating converting Vdc of DC 800 (V) into the three-phase AC voltage of AC 400 (V) (effective value).

In such a case, it is understood that power conversion unit 100X in which voltage target value Vo* is set corresponding to AC 200 V (effective value) can be applied to both power conversion device 500a in FIG. 16 and power conversion device 500b in FIG. 17.

That is, power conversion unit 100X of the second embodiment can be commonly applied to the power conversion devices connected to the power systems having different specifications, so that the extensibility and the versatility with respect to the difference in the specifications of the power systems can be enhanced.

### Third Embodiment

In a third embodiment, a configuration example in which a power conversion device (DC/DC converter) is configured of a plurality of power conversion units 100X to further enhance the versatility with respect to the difference in specifications of the power system will be described.

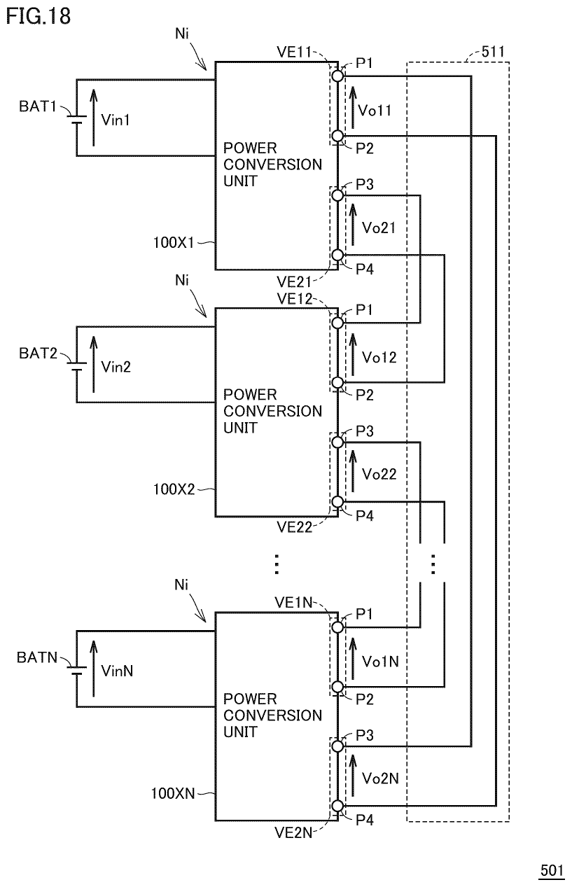

FIG. 18 illustrates a first configuration example of the power conversion device of the third embodiment.

A power conversion device 501 in FIG. 18 includes N (N: an integer of N>2) power conversion units 100X1 to 100XN and an output connector 511.

N batteries (DC power supplies) BAT1 to BATN are connected to input ends Ni of N power conversion units 100X1 to 100XN, respectively. Output connector 511 connects first DC voltage end VE1 (first and second terminals P1, P2) and second DC voltage end VE2 (third and fourth terminals P3, P4) of each power conversion unit 100X to first DC voltage end VE1 and second DC voltage end VE2 of another power conversion units 100X.

Output connector 511 in FIG. 18 connects the output sides (first DC voltage end VE1 and second DC voltage end VE2) of power conversion unit 100X in a circulation extension connection. Specifically, a first DC voltage end VE11 of leading power conversion unit 100X1 is connected in parallel with a second DC voltage end VE2N of last-stage power conversion unit 100XN.

In power conversion unit 100X1 (i: an integer of 2 or more and (N−1) or less) of the intermediate stage, first DC voltage end VE1i is connected in parallel with second DC voltage end VE2i of power conversion unit 100X(i−1) of the preceding stage, and second DC voltage end VE2i is connected in parallel with first DC voltage end VE1(i+1) of power conversion unit 100X(i+1) of the subsequent stage.

For example, in second-stage power conversion unit 100X2, a first DC voltage end VE12 is connected in parallel with s second DC voltage end VE21 of power conversion unit 100X1, and a second DC voltage end VE22 is connected in parallel with the first DC voltage end power of third-stage power conversion unit 100X3 (not illustrated). In addition, first DC voltage end VEIN of power conversion unit 100XN at the final stage is connected in parallel with the second DC voltage end of power conversion unit 100X(N−1) (not illustrated).

Under the circulation extension connection by output connector 511, each of power conversion units 100X performs the output voltage control with the power transmission, whereby each of first voltages Vo11 to Vo1N and second voltages Vo21 to Vo2N of power conversion units 100X1 to 100XN is controlled to voltage target value Vo*.

Thus, in power conversion device 501 connected in the circulation expansion manner, the power of batteries BAT1 to BATN is shared, and first DC voltage end VE1 (first and second terminals P1, P2) and second DC voltage end VE2 (third and fourth terminals P3, P4) of each power conversion unit 100X can be operated as constant voltage sources.

At this point, the proportional gain in the output voltage control in each power conversion unit 100X, specifically, the gain value multiplied by gain multiplication units 62a, 62b (FIGS. 1 and 9) and gain multiplication units 62, 67 (FIGS. 10 and 15) is adjusted according to the power capacity of power conversion unit 100X, so that the power sharing balance can be made appropriate. Specifically, the proportional gain in power conversion unit 100X having the large power capacity can be set large. Alternatively, a state of charge (SOC) balance among N batteries BATT to BATN can be controlled by adjusting the proportional gain according to an SOC or charge energy of battery BAT connected to input end Ni. Specifically, the proportional gain in power conversion unit 100X to which battery BAT having the large SOC or the charge energy is connected can be set high.

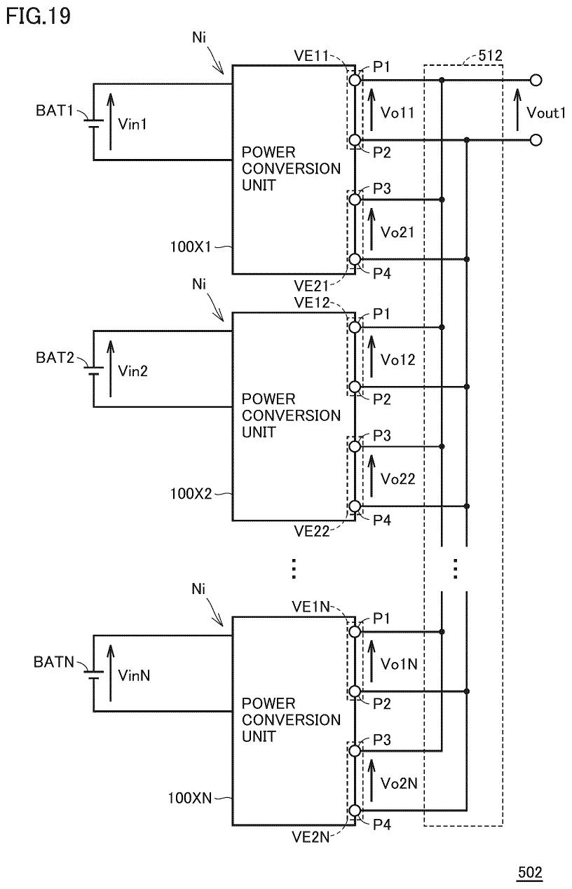

FIG. 19 illustrates a second configuration example of the power conversion device of the third embodiment.

A power conversion device 502 in FIG. 19 includes N power conversion units 100X1 to 100XN and an output connector 512. Similarly to FIG. 17, N batteries BAT1 to BATN are connected to input ends Ni of N power conversion units 100X1 to 100XN, respectively.

Output connector 512 interconnects the output sides (first terminal P1 to fourth terminal P4) of power conversion units 100X so as to connect first DC voltage end VE1 and second DC voltage end VE2 of each power conversion unit 100X in a parallel extension connection. Specifically, by connecting first terminals P1, second terminals P2, third terminals P3, and fourth terminals P4 between power conversion units 100X1 to 100XN, first DC voltage ends VE1 are connected in parallel and second DC voltage ends VE2 are connected in parallel.

Under the parallel extension connection by output connector 512, each of power conversion units 100X performs the output voltage control accompanied by the power transmission, whereby each of first voltages Vo11 to Vo IN and second voltages Vo21 to Vo2N of power conversion units 100X1 to 100XN is controlled to voltage target value Vo*.

Thus, power conversion device 502 can generate output voltage Vout1 controlled to voltage target value Vo* by sharing the power of batteries BAT1 to BATN. Because the power rating of power conversion device 502 outputting output voltage Vout1 corresponds to the sum of the power capacities of power conversion units 100X1 to 100XN, power conversion device 502 is advantageous for application to large power.

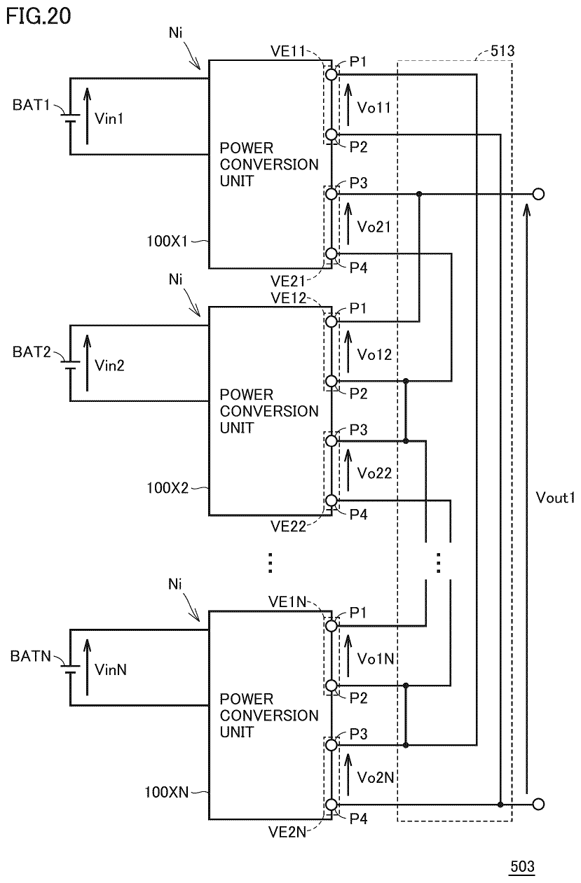

FIG. 20 illustrates a third configuration example of the power conversion device of the third embodiment.

A power conversion device 503 in FIG. 20 includes N (N: an integer of N>2) power conversion units 100X1 to 100XN and an output connector 513. Similarly to FIGS. 17 and 18, N batteries BAT1 to BATN are connected to input ends Ni of the N power conversion units 100X1 to 100XN.

Output connector 513 interconnects the output sides (first terminal P1 to fourth terminal P4) of power conversion unit 100X so as to connect first DC voltage end VE1 and second DC voltage end VE2 of power conversion unit 100X1 to 100XN in a series extension connection. In the series extension connection, a pair of first DC voltage end VE1 and second DC voltage end VE2 connected in parallel in each power conversion unit 100X is connected in series.

Specifically, in leading power conversion unit 100X1, first DC voltage end VE11 is connected in parallel with second DC voltage end VE2N of last-stage power conversion unit 100XN. Second DC voltage end VE21 is connected to first DC voltage end VE1 of second-stage power conversion unit 100X2.

In power conversion units 100X2 to 100XN of the second and subsequent stages, first DC voltage end VE1 and second DC voltage end VE2 are connected in series, and first DC voltage end VE1 is connected in parallel with second DC voltage end VE2 of power conversion unit 100X1 to 100X (N−1) of the preceding stage.

For example, in second-stage power conversion unit 100X2, first DC voltage end VE12 and second DC voltage end VE22 are connected in series, and first DC voltage end VE21 is connected in parallel with second DC voltage end VE21 of preceding-stage power conversion unit 100X1. In final-stage power conversion unit 100XN, first DC voltage end VEIN and second DC voltage end VE2N are connected in series, and first DC voltage end VEIN is connected in parallel with second DC voltage end VE2 of power conversion unit 100X(N−1) (not illustrated). As described above, second DC voltage end VE2N is connected in parallel with first DC voltage end VE11 of power conversion unit 100X1.

Under the series extension connection by output connector 513, each of power conversion units 100X performs output voltage control accompanied by the power transmission, whereby each of first voltages Vo11 to Vo1N and second voltages Vo21 to Vo2N of power conversion units 100X1 to 100XN is controlled to voltage target value Vo*.

Thus, power conversion device 503 can generate output voltage Vout1 controlled to N times voltage target value Vo* between third terminal P3 of power conversion unit 100X1 and fourth terminal P4 of power conversion unit 100XN (Vout1=N·Vo*). Although the power rating of power conversion device 503 corresponds to the minimum value of the power capacities of power conversion units 100X1 to 100XN, power conversion device 502 can be applied to a high voltage.

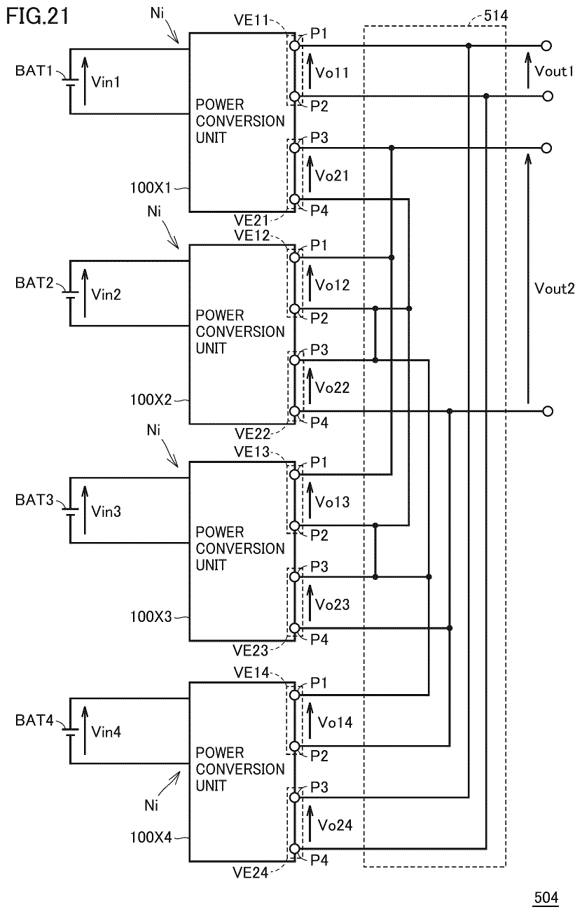

FIG. 21 illustrates a fourth configuration example of the power conversion device of the third embodiment.

A power conversion device 504 in FIG. 21 includes four power conversion units 100X1 to 100X4 and an output connector 514. Batteries BAT1 to BAT4 are connected to input ends Ni of the four power conversion units 100X1 to 100X4.

Output connector 514 interconnects the output sides (first terminal P1 to fourth terminal P4) of power conversion unit 100X1 to 100X4 so as to connect first DC voltage end VE1 and second DC voltage end VE2 of power conversion unit 100X1 to 100X4 in a series-parallel extension connection.

In the example of FIG. 21, first DC voltage end VE11 of power conversion unit 100X1 and second DC voltage end VE2N of power conversion unit 100XN are connected in parallel to generate output voltage Vout1.

On the other hand, in power conversion units 100X2 and 100X3 of the second and third stages, first DC voltage end VE12 and second DC voltage end VE22 are connected in series, and first DC voltage end VE13 and second DC voltage end VE23 are connected in series. Furthermore, second DC voltage end VE21, first DC voltage end V12, and first DC voltage end VE13 are connected in parallel between power conversion units 100X1 to 100X3. Second DC voltage end VE22, second DC voltage end V23, and first DC voltage end VE14 are connected in parallel between power conversion units 100X2 to 100X4.

Thus, in each of the power conversion units 100X2 to 100X4, first DC voltage end VE1 and second DC voltage end VE2 are connected in series, and first DC voltage end VE1 and second DC voltage end VE2 connected in series are connected in parallel with each other. Accordingly, power conversion device 504 in which four power conversion units 100X1 to 100X4 are connected in series-parallel extension can generate output voltage Vout2 controlled twice voltage target value Vo* (Vout2=N·Vo*).

In this manner, power conversion device 504 can generate the plurality of output voltages Vout1, Vout2 using the plurality of power conversion units 100X connected in series-parallel extension. The connection mode by output connector 514 is not limited to the example in FIG. 21, but the output voltage of M times (M: an integer of M≤N) voltage target value Vo* can be appropriately generated.

As described above, according to the power conversion device of the third embodiment, the output sides (first DC voltage end VE1 and second DC voltage end VE2) of the plurality of power conversion units 100X are connected in the parallel extension, the series extension, or the series-parallel extension, so that one or the plurality of output voltages controlled to an integral multiple of voltage target value Vo* can be generated within the range of 1 to N times the output voltage (first voltage Vo1 or second voltage Vo1) of each power conversion unit 100X.

In addition, using the circulation extension connection in FIG. 18, after the output voltage (first voltage Vo1 or second voltage Vo2) of each power conversion unit 100X is accurately controlled to voltage target value Vo*, the power converter (DC/DC converter) can be connected to the load (inverter or the like) through the parallel extension connection, the series extension connection, or the series-parallel extension connection. Alternatively, in power conversion device 501 (FIG. 18) to which the circulation extension connection is applied, the DC voltage can also be applied to a different load in each constant voltage source (first voltage Vo1 or second voltage Vo2). On the other hand, in power conversion device 502 to 504 in FIGS. 19 to 21, output voltage Vout1 or output voltages Vout1, Vout2 obtained by the parallel extension connection, the series extension connection, or the series-parallel extension connection by output connector 512 to 514 are supplied to the load (inverter or the like).

Output connector 511 to 514 in FIGS. 18 to 21 can be configured by fixedly connecting terminals by a busbar (not illustrated) or the like. Alternatively, as in PTL 1, the output connector can be configured such that the connection mode can be changed at any time by an assembly of a busbar and a relay (not illustrated). For example, by changing the on and off of the relay, a connection relationship can be switched among the circulation extension connection (FIG. 18), the parallel extension connection (FIG. 19), the series extension connection (FIG. 20), and the series-parallel extension connection (FIG. 21).

### Fourth Embodiment

In a third embodiment, a case where battery BAT (DC power supply) is connected to input ends Ni of all power conversion units 100X is assumed. However, when the in-vehicle battery is assumed, it is understood that there is a need to operate the entire power converter even when battery BAT (DC power supply) is non-connected with input end Ni in a part of the power conversion unit configuring the power conversion device.

Therefore, in a fourth embodiment, the control of the power conversion unit coping with the non-connection of battery BAT will be described.

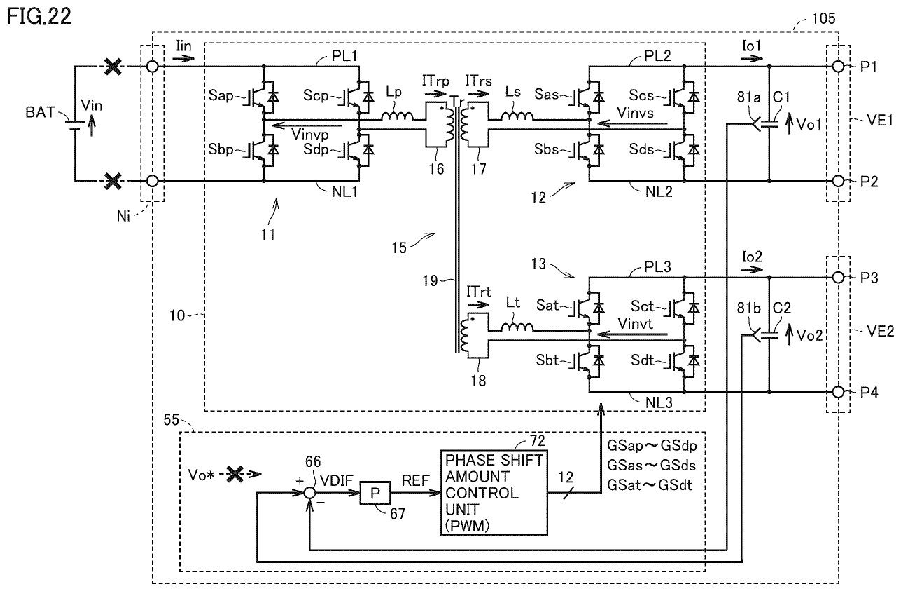

FIG. 22 is a circuit diagram illustrating a configuration of a power conversion unit 105 of the fourth embodiment.

As illustrated in FIG. 22, power conversion unit 105 of the fourth embodiment is different from power conversion unit 100 (FIG. 1) of the first embodiment in that a controller 55 is included instead of controller 50. Converter 10 has the DAB configuration similar to that of FIG. 1.

As illustrated in FIG. 22, controller 55 has a control function when battery BAT is non-connected with input end Ni. Controller 55 performs the control to balance first voltage Vo1 and second voltage Vo1 described in controller 53 with no use of voltage target value Vo*.

Controller 55 includes a subtraction unit 66, a gain multiplication unit 67, and a phase shift amount control unit 72. Subtraction unit 66 calculates voltage difference VDIF (VDIF=Vo2−Vo1) between first voltage Vo1 and second voltage Vo1. Gain multiplication unit 67 generates command value REF bringing voltage difference VDIF close to zero by multiplying voltage difference VDIF from subtraction unit 66 by a predetermined proportional gain. That is, command value REF in FIG. 22 is the command value balancing first voltage Vo1 and second voltage Vo2 similarly to command value BAL in FIGS. 10 and 15.

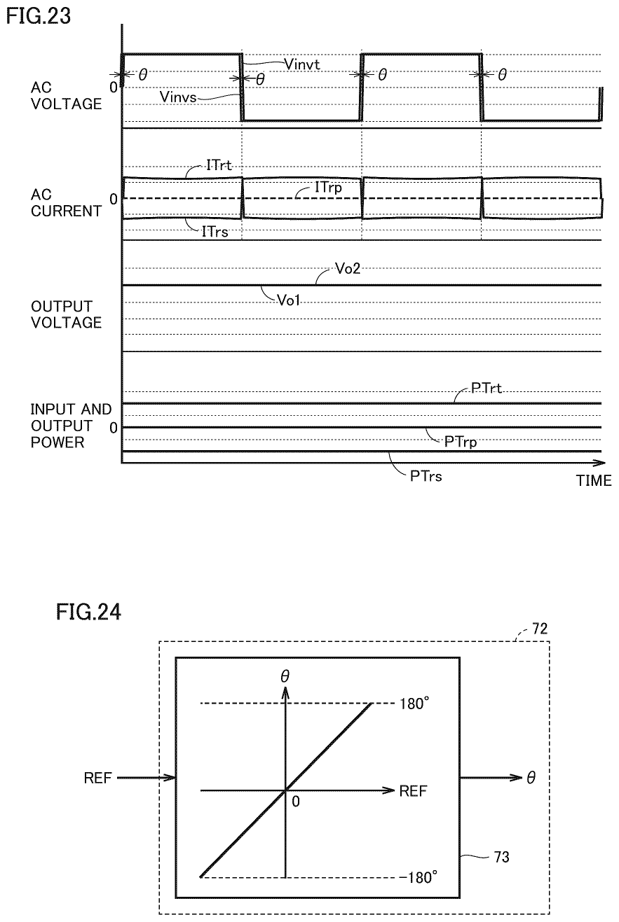

FIG. 23 illustrates an operation waveform example of converter 10 in power conversion unit 105 in FIG. 22. Similarly to FIG. 2 and the like, FIG. 23 also illustrates input voltage Vin, AC voltages Vinvs and Vinvt, AC currents ITrp, ITrs, ITrt, first voltage Vo1 and second voltage Vo2 as the output voltages, and AC powers PTrp. PTrs, PTrt as the input and output power of transformer 15.

FIG. 23 illustrates a simulation waveform when battery BAT is not connected to first bridge 11 (input end Ni), when the voltage source (not illustrated) is connected to second bridge 12 (first DC voltage end VE1), and when the load (not illustrated) is connected to third bridge 13 (second DC voltage end VE2).

Power is not input from battery BAT to first bridge 11 of converter 10. As a result, in first bridge 11, switching elements Sap to Sdp are fixed to off, and the switching is stopped. Accordingly, AC voltage Vinvp is not output to primary winding 16 of transformer 15, and current ITrp from first bridge 11 to primary winding 16 is fixed at zero.

Controller 55 in FIG. 22 controls phase shift amount θ between AC voltage Vinvs of second bridge 12 and AC voltage Vinvt of third bridge 13 according to command value REF. Phase shift amount θ is defined as θ>0 when the phase of AC voltage Vinvs (second bridge 12) is advanced with respect to the phase of AC voltage Vinvt (third bridge 13).

FIG. 24 is a conceptual diagram illustrating the operation of phase shift amount control unit 72 in FIG. 21.

As illustrated in FIG. 24, phase shift amount control unit 72 includes an arithmetic unit 73. Arithmetic unit 73 calculates phase shift amount θ from command value REF according to a linear function similar to arithmetic units 73a, 73b in FIG. 3. That is, when REF=0 (Vo1=Vo2), phase shift amount θ=0 is set, and the switching of second bridge 12 and third bridge 13 is controlled such that REF<0 (Vo2<when Vo1), θ0>0, namely, the phase of AC voltage Vinvs of second bridge 12 advances with respect to the phase of AC voltage Vinvt of third bridge 13. On the contrary, when REF>0 (Vo2>Vo1), the switching of second bridge 12 and third bridge 13 is controlled such that θ0>0, namely, the phase of the AC voltage Vinvs of second bridge 12 is delayed from the phase of AC voltage Vinvt of third bridge 13. Arithmetic unit 73 can also be configured as a numerical calculator or a lookup table according to the linear function in FIG. 24.

Furthermore, phase shift amount control unit 70 generates gate signals GSas to GSds and GSat to GSdt turning on and off switching elements Sas to Sds of second bridge 12 and switching elements Sat to Sdt of third bridge 13 so as to implement calculated phase shift amount θ. On the other hand, phase shift amount control unit 70 generates gate signals GSap to GSdp so as to turn off and fix switching elements Sap to Sdp of first bridge 11.

In FIG. 23, in the state where first voltage Vo1 and second voltage Vo2 are balanced, the power is transmitted from the voltage source (not illustrated) connected to second bridge 12 to the load (not illustrated) connected to third bridge 13. For this reason, phase shift amount θ=0, and AC current ITrt of second bridge 12 and AC current ITrs of third bridge 13 have opposite phases.

Because battery BAT is not connected to input end Ni, the power input to transformer 15 by first bridge 11 in which the switching is stopped is zero (PTrp=0). The power from the above-described voltage source is input from second bridge 12 to transformer 15, output from transformer 15 to third bridge 13, and transmitted to the above-described load. Accordingly, AC power PTrs (effective value) input from transformer 15 to second bridge 12 is a negative value, and a relationship of PTrs=−PTrt holds between AC power PTrt (effective value) input from transformer 15 to third bridge 13 and AC power PTrs (effective value).

That is, when battery BAT is non-connected with input end Ni, the output voltage control can be executed so as to balance first voltage Vo1 and second voltage Vo2 by power transmission between first DC voltage end VE1 (first capacitor C1) and second DC voltage end VE2 (second capacitor C2) through second bridge 12 and third bridge 13. As described above, according to power conversion unit 105 including controller 55, the control operation of the output voltage (first voltage Vo1 and second voltage Vo2) can be executed even when battery BAT is non-connected.

Power conversion unit 101 to 103 described in the first embodiment and the modifications thereof and power conversion unit 105 of the third embodiment are different from each other only in controllers 51 to 53 and controller 55, and the basic configuration of converter 10 is the same. For this reason, by providing the switching function of the control operation by the controller, the configuration for the power conversion unit that can support both the connection and the non-connection of battery BAT (DC power supply) can be implemented.

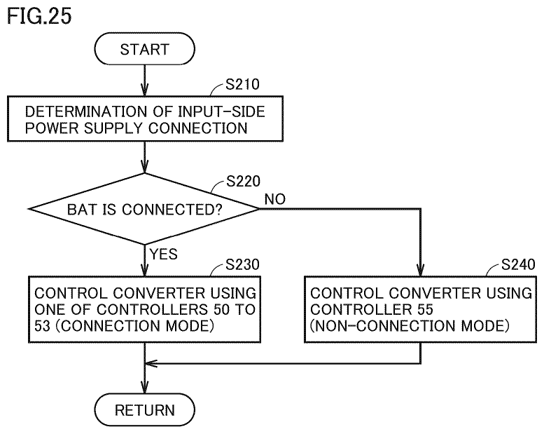

FIG. 25 is a flowchart illustrating a control operation switching function by the controller of the power conversion unit of the fourth embodiment.

As illustrated in FIG. 25, in S210, the controller executes input-side power supply connection determination to determine connection and non-connection of battery BAT (DC power supply) to input end Ni of the power conversion unit. For example, when the connection signal of the DC power supply is input from the outside of the power conversion unit, the input-side power supply connection determination can be executed based on the presence or absence of the connection signal. Normally, in the charge standard of the electric vehicle such as CHAdeMO (registered trademark) described above, a signal notifying the connection of the in-vehicle battery is transmitted from the automobile side to the charger side by controller area network (CAN) communication, so that the input-side power supply connection determination can be executed using the signal.

Alternatively, the input-side power supply connection determination in S210 can also be executed by determining whether the voltage or the current associated with the connection of battery BAT (DC power supply) is generated based on the detection value of the voltage or the current of input end Ni.

When battery BAT is connected (YES in S220), the controller executes the control operation in the connection mode in S230. Specifically, gate signals GSap to GSdp, GSas to GSds, GSat to GSdt controlling converter 10 are generated similarly to any one of controllers 50 to 53 described in the first embodiment and the modifications thereof.

On the other hand, when battery BAT is non-connected (when negative determination in S220), the control operation in the non-connection mode is executed in S240. Specifically, gate signals GSap to GSdp, GSas to GSds, GSat to GSdt controlling converter 10 are generated similarly to controller 55. As described above, in the non-connection mode, the gate signals GSap to GSdp are generated so as to turn off and fix the switching elements Sap to Sdp of first bridge 11.

Alternatively, in the non-connection mode, among the gate signals GSap to GSdp, GSas to GSds, GSat to GSdt generated by controllers 50 to 53 similar to the connection mode, gate signals GSap to GSdp corresponding to first bridge 11 may be masked, and switching elements Sap to Sdp (first bridge 11) may be turned off and fixed. On the other hand, second bridge 12 and third bridge 13 can control first voltage Vo1 and second voltage Vo1 according to voltage target value Vo* in response to gate signals GSas to GSds and GSat to GSdt.

As a result, the output voltage control corresponding to both the connection time and the non-connection time of battery BAT (DC power supply) can be executed in the power conversion unit of the fourth embodiment. The connection mode corresponds to an example of the “first mode”, and the non-connection mode corresponds to an example of the “second mode”.

Modification of fourth embodiment.

In a modification of the fourth embodiment, a configuration of a power conversion device (DC/DC converter) equivalent to the third embodiment using the power conversion unit of the fourth embodiment described with reference to FIGS. 22 to 25 will be described.

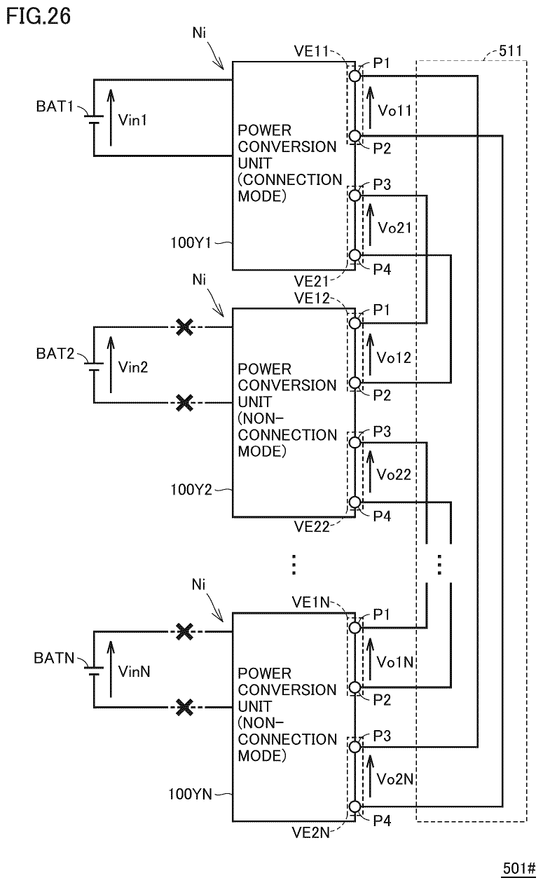

FIG. 26 illustrates a first configuration example of the power conversion device according to the modification of the fourth embodiment.

A power conversion device 501 # in FIG. 26 includes N (N: an integer of N>2) power conversion units 100Y1 to 100YN and an output connector 511 similar to power conversion device 501 (FIG. 18).

Each of N power conversion units 100Y1 to 100YN (hereinafter, also referred to as a power conversion unit 100Y) is the power conversion unit of the fourth embodiment described with reference to FIGS. 22 to 25, and has the switching function between the connection mode and the non-connection mode described with reference to FIG. 25.

In some of N power conversion units 100Y1 to 100YN, battery BAT is non-connected with input end Ni. In FIG. 25, while battery BAT1 is connected to power conversion unit 100Y1, battery BAT is not connected to input end Ni of power conversion unit 100Y2 to 100YN.

The output sides (first DC voltage end VE1 and second DC voltage end VE2) of power conversion unit 100Y1 to 100YN are connected by output connector 511 in the circulation extension connection similarly to in FIG. 18.

In power conversion device 501 #, power conversion unit 100Y1 is operated in the connection mode, and each of power conversion units 100Y2 to 100YN is operated in the non-connection mode. Thus, using the power of battery BAT1, first voltage Vo11 and second voltage Vo21 are controlled to voltage target value Vo* in power conversion unit 100Y1, and the control is executed to bring the voltage difference between first voltage Vo1 and second voltage Vo2 close to zero in power conversion unit 100Y2 to 100YN.

In power conversion device 501 #, each of first voltage Vo11 and second voltage Vo21 are controlled to the voltage target value in power conversion unit 100Y1. Furthermore, in each of power conversion units 100Y2 to 100YN, the output voltage is controlled to be equivalent to first voltage Vo1 and second voltage Vo2.

Furthermore, in power conversion unit 100Y1, first DC voltage end VE11 is connected to second DC voltage end VE2N of power conversion unit 100YN, and second DC voltage end VE21 is connected to first DC voltage end VE12 of power conversion unit 100Y2. In power conversion unit 100Y2 to 100Y(N−1) (not illustrated), first DC voltage end VE1 and second DC voltage end VE2 are connected to second DC voltage end VE2 and first DC voltage end VE1 of the adjacent power conversion unit.

As a result, also in each of power conversion units 100Y2 to 100YN, first voltage Vo1 and second voltage Vo2 can be controlled to the voltages equivalent to first voltage Vo11 and second voltage Vo21 of power conversion unit 100Y1.

Accordingly, even when battery BAT (DC power supply) is non-connected with some of power conversion units 100Y, power conversion device 501 # can operate using first DC voltage end VE1 and second DC voltage end VE2 of each power conversion unit 100Y as the constant voltage source similarly to power conversion device 501.

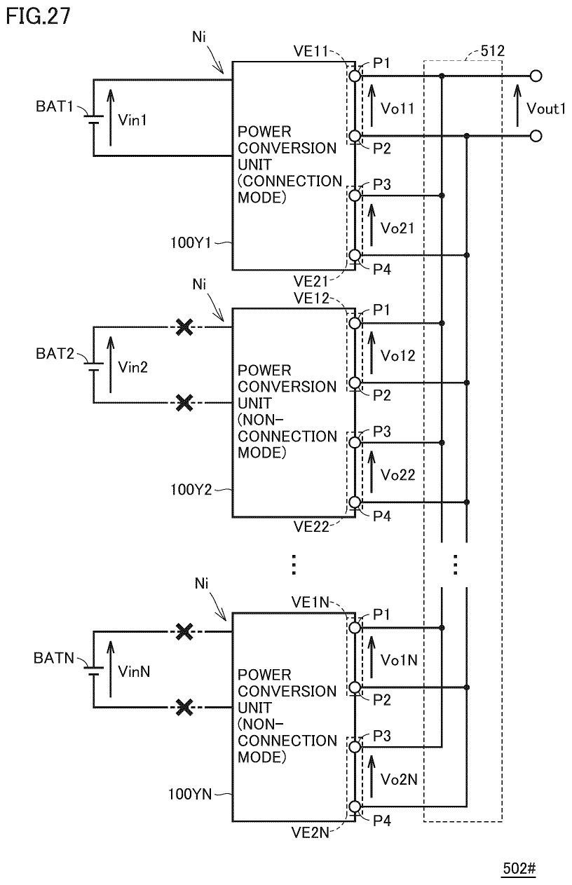

FIG. 27 illustrates a second configuration example of the power conversion device according to the modification of the fourth embodiment.

A power conversion device 502 # in FIG. 27 includes N power conversion units 100Y1 to 100YN and an output connector 512 similar to power conversion device 502 (FIG. 19).

Also in FIG. 27, similarly to FIG. 26, while battery BAT1 is connected to power conversion unit 100Y1, battery BAT is not connected to input end Ni of power conversion unit 100Y2 to 100YN.

The output sides (first DC voltage end VE1 and second DC voltage end VE2) of power conversion unit 100Y1 to 100YN are connected by output connector 512 in the parallel extension connection similarly to FIG. 19. Also in power conversion device 502 #, power conversion unit 100Y1 is operated in the connection mode, and each of power conversion units 100Y2 to 100YN is operated in the non-connection mode.

Thus, first voltage Vo11 and second voltage Vo21 are controlled to voltage target value Vo* in power conversion unit 100Y1 using the power of battery BAT1. Furthermore, in power conversion unit 100Y2 to 100YN, the control is executed so as to bring the voltage difference between first voltage Vo1 and second voltage Vo2 close to zero.

In power conversion device 502 #, first DC voltage ends VE12 to VEIN and second DC voltage ends VE21 to VE2N of power conversion unit 100Y2 to 100YN are connected in parallel with first DC voltage end VE11 and second DC voltage end VE21 of power conversion unit 100Y1.

As a result, also in each of power conversion units 100Y2 to 100YN, first voltage Vo1 and second voltage Vo2 can be controlled to the voltages equivalent to first voltage Vo11 and second voltage Vo21 of power conversion unit 100Y1.

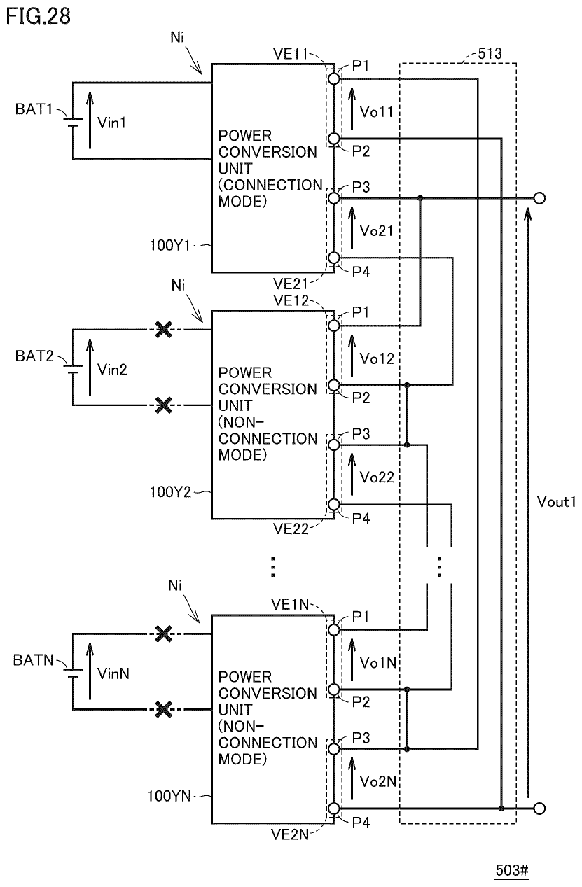

Accordingly, even when battery BAT is non-connected with some of power conversion units 100Y, power conversion device 502 # can generate output voltage Vout1 controlled to voltage target value Vo* similar to power conversion device 502. FIG. 28 illustrates a third configuration example of the power conversion device according to the modification of the fourth embodiment.

A power conversion device 503 # in FIG. 28 includes N power conversion units 100Y1 to 100YN and an output connector 513 similar to power conversion device 503 (FIG. 20).

Also in FIG. 27, similarly to FIGS. 26 and 27, while battery BAT1 is connected to power conversion unit 100Y1, battery BAT is not connected to input end Ni of power conversion unit 100Y2 to 100YN.

The output sides (first DC voltage end VE1 and second DC voltage end VE2) of power conversion unit 100Y1 to 100YN are series extension connected by output connector 513 similarly to FIG. 20. Also in power conversion device 503 #, power conversion unit 100Y1 is operated in the connection mode, and each of power conversion units 100Y2 to 100YN is operated in the non-connection mode.

Thus, using power of battery BAT1, first voltage Vo11 and second voltage Vo21 are controlled to voltage target value Vo* in power conversion unit 100Y1, and the control is executed to bring the voltage difference between first voltage Vo1 and second voltage Vo2 close to zero in power conversion unit 100Y2 to 100YN. As a result, similarly to FIGS. 26 and 27, also in each of power conversion units 100Y2 to 100YN, first voltage Vo1 and second voltage Vo2 can be controlled to the voltages equivalent to first voltage Vo11 and second voltage Vo21 of power conversion unit 100Y1.

Accordingly, even when battery BAT (DC power supply) is non-connected with some of power conversion units 100Y, power conversion device 503 # can generate output voltage Vout1 controlled to N times voltage target value Vo* similar to power conversion device 503 (Vout1=N·Vo*).

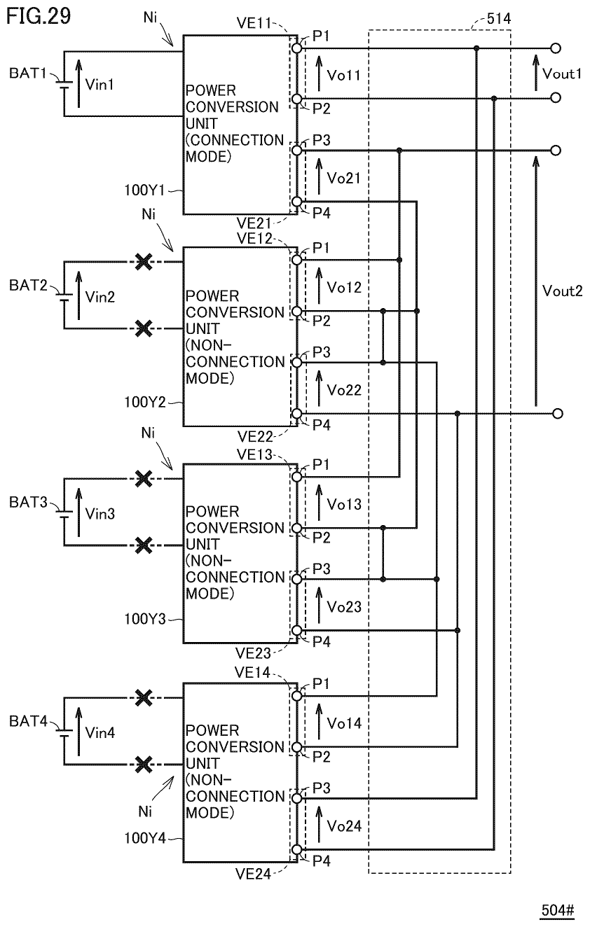

FIG. 29 illustrates a fourth configuration example of the power conversion device according to the modification of the fourth embodiment.

A power conversion device 504 # in FIG. 29 includes four power conversion units 100Y1 to 100Y4 and an output connector 514 similar to power conversion device 504 (FIG. 21).

Also in FIG. 29, similarly to FIGS. 26 to 28, battery BAT1 is connected to input end Ni of power conversion unit 100Y1, while battery BAT is not connected to input end Ni of power conversion unit 100Y2 to 100Y4.

The output side (first DC voltage end VE1 and second DC voltage end VE2) of power conversion unit 100Y1 to 100Y4 is connected by output connector 514 in the series-parallel extension connection similarly to FIG. 21. Also in power conversion device 503 #, power conversion unit 100Y1 is operated in the connection mode, and each of power conversion units 100Y2 to 100Y4 is operated in the non-connection mode.

Thus, using the power of battery BAT1, first voltage Vo11 and second voltage Vo21 are controlled to voltage target value Vo* in power conversion unit 100Y1, and the control is executed to bring the voltage difference between first voltage Vo1 and second voltage Vo2 close to zero in power conversion unit 100Y2 to 1004. As a result, similarly to FIGS. 26 to 28, in each of power conversion units 100Y2 to 100Y4, first voltage Vo1 and second voltage Vo2 can be controlled to the voltages equivalent to first voltage Vo11 and second voltage Vo21 of power conversion unit 100Y1.

As a result, power conversion device 504 # can generate a plurality of output voltages Vout1 and Vout2 similar to those of power conversion device 504 even when battery BAT (DC power supply) is non-connected with some of power conversion units 100Y.

As described above, according to power conversion devices 501 # to 504 # of the modification of the fourth embodiment, even when battery BAT (DC power supply) is non-connected with some power conversion units 100Y, the same operation as power conversion device 501 to 504 described in the third embodiment can be executed with no change of the connection configuration at output connector 511 to 514. That is, even when the connection and the non-connection of battery BAT (DC power supply) in each power conversion unit 100Y is switched, the operation of power conversion devices 501 # to 504 # can be maintained by switching the connection model and the non-connection mode in the power conversion unit.

Although not illustrated, the power conversion devices 500a, 500b of the second embodiment in FIGS. 16 and 17 can be configured using one power conversion unit 100Y to which the DC power supply (battery BAT) is connected to operate in the connection mode.

In the present embodiments, the state in which the DC power supply (battery BAT) is “non-connected” includes a state in which the electrically-connected DC power supply (battery BAT) is unusable due to the decrease in SOC, an abnormality, or the like in addition to the state in which input ends Ni of the power conversion units 100X, 100Y are not electrically connected with the DC power supply (battery) BAT.

### Fifth Embodiment

In a fifth embodiment, a configuration example of a power conversion system using the power conversion device of the fifth embodiment will be further described. As described in the second embodiment, a power conversion system according to the fifth embodiment means a system connected between the DC power supply (battery BAT) and the AC power system.

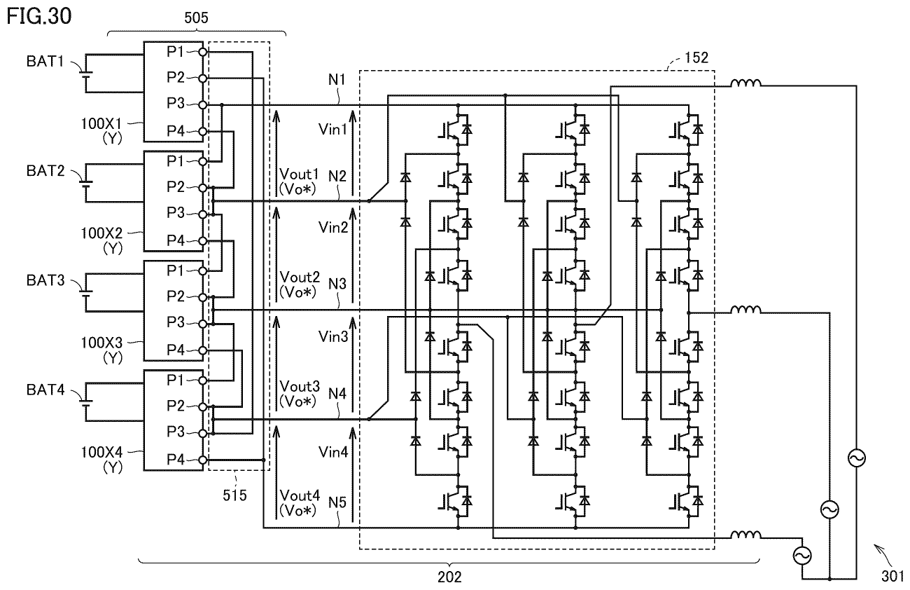

FIGS. 30 to 34 illustrate first to fourth configuration examples of the power conversion system of the fifth embodiment.

As illustrated in FIG. 30, a power conversion system 202 according to the first configuration example of the fifth embodiment is connected between batteries BAT1 to BAT4 and AC power system 301. Power conversion system 202 includes a power conversion device 505 including four power conversion units 100X1 to 100X4 and an inverter (DC/AC converter) 152.

The output sides of power conversion unit 100X1 to 100X4 are connected in the series-parallel connection, and generates output voltages Vout1 to Vout4 as illustrated in the drawing. Each of output voltages Vout1 to Vout4 is controlled to the voltage corresponding to voltage target value Vo* by connecting first DC voltage end VE1 and second DC voltage end VE2 of the different power conversion units 100X in parallel.

Because the voltage terminals that output the output voltages Vout1 to Vout4 are connected in series, five stages of DC voltages of 0, Vo*, 2.Vo*, 3.Vo*, and 4Vo* can be extracted on the output side of power conversion device 505.

Inverter 152 has a configuration of a general 5-level three-phase inverter. The AC side of each phase of the three-phase inverter is connected to each phase of AC power system 301. On the other hand, on the DC side of the three-phase inverter, output voltage Vout1 of power conversion device 505 is provided as input voltage Vin between input nodes N1, N2. Similarly, between input nodes N2, N3, between input nodes N3, N4, and between input nodes N4, N5, output voltages Vout2, Vout3, Vout4 of power conversion device 505 are provided as input voltages Vint, Vin3, Vin4.

Accordingly, the DC voltage equivalent to 4 times Vo* can be input to the DC side of inverter 152. Thus, inverter 152 including the 5-level three-phase inverter can perform DC/AC conversion using input voltages Vin1 to Vin4 so as to set the AC-side output terminal voltage of each phase to any one of the 5 levels of 2·Vo*, Vo*, 0, −Vo*, and −2.Vo*.

As a result, according to power conversion system 202, after input voltages Vin1 to Vin4 to inverter 152 (5-level three-phase inverter) are controlled to be constant by the output voltage control, the power transmission can be performed between batteries BAT1 to BAT4 connected to power conversion unit 100X1 to 100X4 and AC power system 301. In power conversion system 202, the device can be miniaturized by effectively utilizing the output side of power conversion unit 100X.

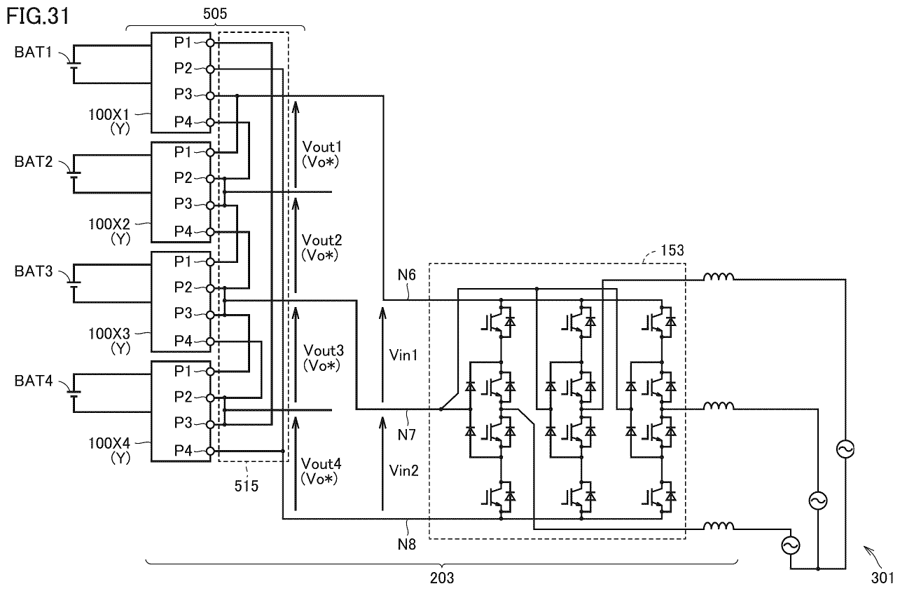

As illustrated in FIG. 31, a power conversion system 203 according to the second configuration example of the fifth embodiment is connected between batteries BAT1 to BAT4 and AC power system 301. Power conversion system 202 includes power conversion device 505 similar to that in FIG. 30 and an inverter (DC/AC converter) 153.

Similarly to FIG. 30, power conversion device 505 generates output voltages Vout1 to Vout4 each of which is controlled to correspond to voltage target value Vo*. Voltage terminals that output the output voltages Vout1 to Vout4 are connected in series.

Inverter 153 has a general 3-level three-phase inverter configuration. The AC side of each phase of the three-phase inverter is connected to each phase of AC power system 301. On the other hand, on the DC side of the three-phase inverter, between input nodes N6, N7 and between input nodes N7, N8, DC voltages equivalent to twice voltage target value Vo* generated by connecting the two DC voltage ends in series from power conversion device 505 are provided as input voltages Vin1, Vin2 (Vin1=Vin2=2.Vo*).

Accordingly, the DC voltage equivalent to 4 times Vo* can be input to the DC side of inverter 153. Thus, inverter 153 including three-level three-phase inverters can perform DC/AC conversion using input voltages Vin1, Vin2 so as to set the AC-side voltage of each phase to one of three levels of 2Vo*, 0, and −2.Vo*.

As a result, according to power conversion system 203, after input voltages Vin1, Vin2 to inverter 153 (three-level three-phase inverter) are controlled to be constant by the output voltage control, the power transmission can be performed between batteries BAT1 to BAT4 connected to power conversion unit 100X1 to 100X4 and AC power system 301. Also in power conversion system 203, the device can be miniaturized by effectively utilizing the output side of power conversion unit 100X.

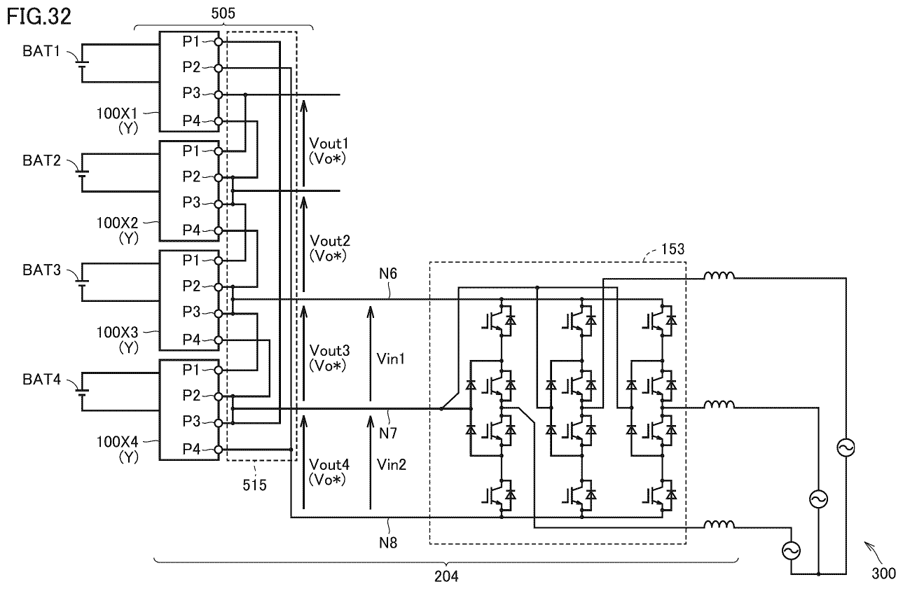

A power conversion system 204 according to the third configuration example of the fifth embodiment in FIG. 32 includes power conversion device 505 and inverter (DC/AC converter) 153 similarly to power conversion system 203 in FIG. 31. Power conversion system 204 is connected between batteries BAT1 to BAT4 and AC power system 300. AC power system 300 has an AC voltage (amplitude or effective value) of ½ as compared with AC power system 301 in FIGS. 30 and 31.

Power conversion system 204 is different from power conversion system 203 in the connection between the output side of power conversion device 505 and the DC side of inverter 153. That is, each one DC voltage end among the four DC voltage ends connected in series in power conversion device 500 is connected between input nodes N6, N7 and between input nodes N7, N8 of inverter 153 (three-level three-phase inverter). Accordingly, each of input voltages Vin1. Vin2 of inverter 153 corresponds to voltage target value Vo* (Vin1=Vin2=Vo*).

Accordingly, the DC voltage equivalent to 2 times Vo* can be input to the DC side of inverter 153. Thus, inverter 153 including three-level three-phase inverters can perform DC/AC conversion using input voltages Vin1, Vin2 so as to set the AC-side voltage of each phase to one of three levels of Vo*, 0, and Vo*.

As a result, according to power conversion system 204, after input voltages Vin1, Vin2 to inverter 153 (three-level three-phase inverter) are controlled to be constant by the output voltage control, the power transmission can be performed between batteries BAT1 to BAT4 connected to power conversion unit 100X1 to 100X4 and AC power system 300.

As can be understood from FIGS. 31 and 32, power conversion device 505 of the fifth embodiment can be applied to AC power systems having different AC voltages only by switching the connection point with the subsequent inverter. That is, it is understood that the expandability and the versatility are improved with respect to the difference in the specification of the power system.

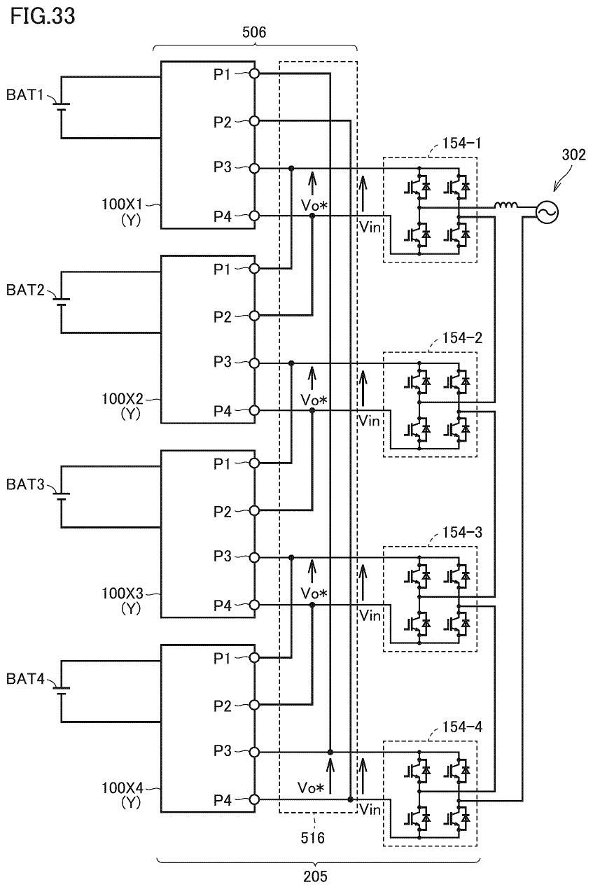

A power conversion system 205 according to the fourth configuration example of the fifth embodiment in FIG. 33 is connected between batteries BAT1 to BAT4 and an AC power system 302. AC power system 302 is a single-phase AC system.

Power conversion system 205 includes a power conversion device 506 including four power conversion units 100X1 to 100X4 and inverters (DC/AC converters) 154-1 to 154-4.

The output sides of power conversion unit 100X1 to 100X4 are connected in the circulation extension connection similarly to power conversion device 501 in FIG. 18, and the DC voltage corresponding to voltage target value Vo* can be extracted from first DC voltage end VE1 and second DC voltage end VE2 of each power conversion unit 100Y.

Each of inverters 154-1 to 154-4 has a general single-phase inverter configuration. The DC voltage equivalent to voltage target value Vo* is input to the DC side of each of inverters 154-1 to 154-4.

Each of inverters 154-1 to 154-4 outputs two-level voltages (single-phase AC voltage) of Vo* and −Vo*. The AC output terminals of inverters 154-1 to 154-4 are connected in series and connected to AC power system 302. Inverters 154-1 to 154-4 are controlled by a host controller (not illustrated) to generate AC voltages of the same phase, so that the AC voltage having an AC amplitude of 4·Vo* can be input to AC power system 302.

As a result, according to power conversion system 205, after the input voltage to inverters 151-1 to 151-4 (single-phase inverter) is controlled to be constant by the output voltage control, the power transmission can be performed between batteries BAT1 to BAT4 connected to power conversion unit 100X1 to 100X4 and AC power system 302 (single phase). According to power conversion device 506, it is understood that the AC power system (single phase) having different voltages can be coped with by changing the number of inverters connected in series.

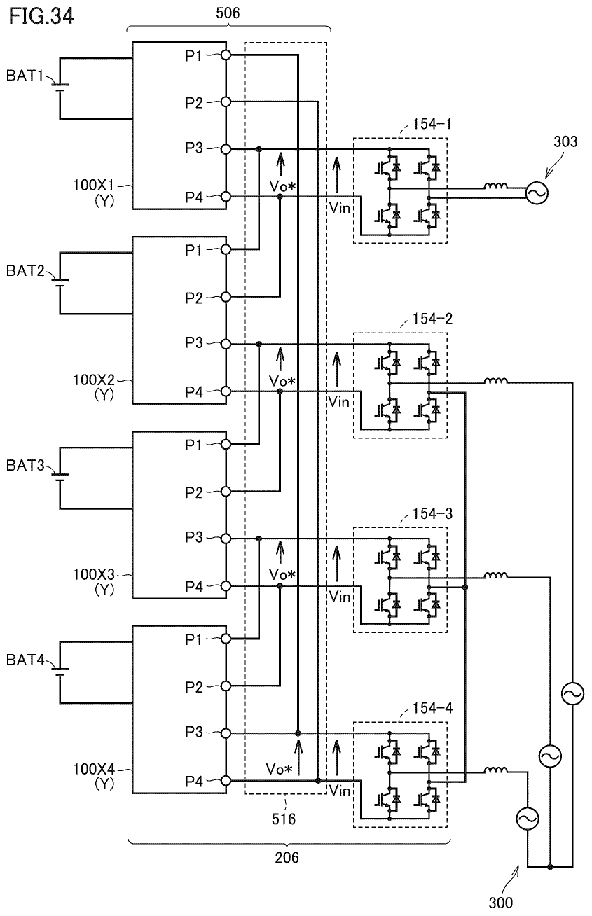

A power conversion system 206 according to the fifth configuration example of the fifth embodiment in FIG. 34 includes a power conversion device 506 and inverters (DC/AC converters) 154-1 to 154-4 similarly to the power conversion system 205.

Power conversion system 206 is different from power conversion system 205 in the connection relationship between the AC side of inverters 151-1 to 151-4 and the power system. Similarly to FIG. 33, each of inverters 151-1 to 151-4 converts the DC voltage equivalent to voltage target value Vo* into the AC voltage and generates the AC voltage at the AC output terminal.

The AC output terminal of inverter 151-1 is connected to an AC power system 303. AC power system 303 has a single phase similarly to AC power system 302 (FIG. 33), but is different from AC power system 302 in that the amplitude of the AC voltage is equivalent to Vo*.

The AC outputs of inverters 151-2 to 151-4 are output to the respective phases of three-phase AC power system 300 similarly to FIG. 32. Thus, the AC voltage having the AC amplitude of Vo* can be input to each phase of AC power system 300.

As a result, according to power conversion system 206, after the input voltage to inverters 151-1 to 151-4 (single-phase inverter) is controlled to be constant by the output voltage control, the power transmission can be performed between batteries BAT1 to BAT4 connected to power conversion unit 100X1 to 100X4 and both AC power systems 302 (single-phase), 300 (three-phase). As described above, the power conversion device according to the fifth embodiment can also be applied to the connection with a plurality of AC power systems.

It is understood through the fifth embodiment that power conversion system 202 to 205 configured using the power conversion unit 100X of the fifth embodiment can be applied to the power systems of single phase, three phase, and different AC voltages in common, and has the high extensibility and versatility with respect to the difference in specifications of the power system.

In each power conversion system 202 to 205 described in the fifth embodiment, each power conversion unit 100X can be replaced with power conversion unit 100Y described in the third embodiment. In this way, even when the connection and the non-connection of battery BAT (DC power supply) to each power conversion unit 100Y changes, each of power conversion systems 202 to 205 can continuously operate by switching the connection mode and the non-connection mode in the power conversion unit 100Y. Accordingly, the expandability of the number of DC power supplies (in-vehicle batteries) connected to the power conversion device can be enhanced.

In addition, the configuration of converter 10 in power conversion units 100X, 100Y is not limited to the example in FIG. 1 and the like, but can be appropriately modified as long as the power transmission associated with the output voltage control (Vo1, Vo2) can be performed between input end Ni and first DC voltage end VE1 (first and second terminals P1, P2) and second DC voltage end VE2 (third and fourth teiminals P3, P4).

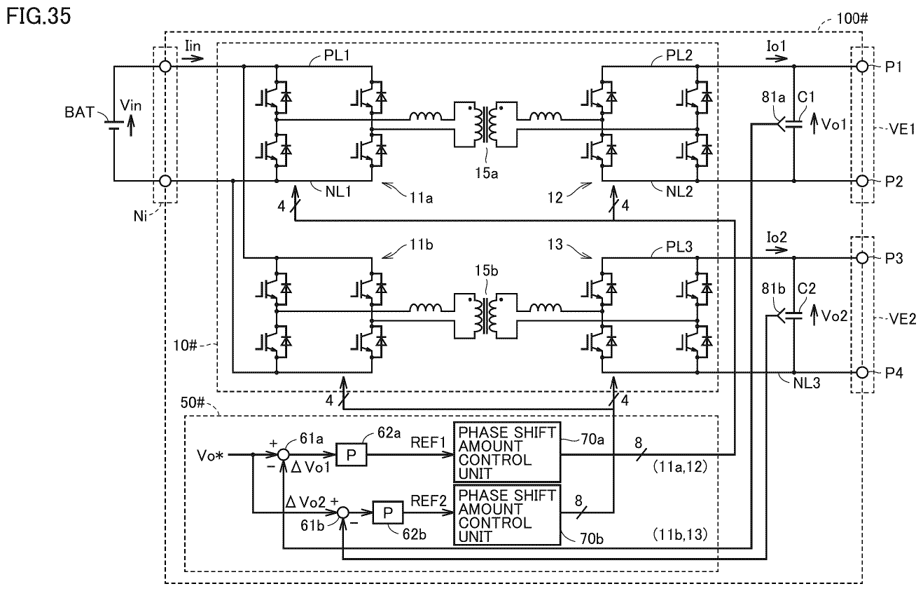

FIG. 35 illustrates a modification of the configuration of the converter in the power conversion unit.

A power conversion unit 100 # in FIG. 35 includes a converter 10 # instead of converter 10 and a controller 50 # instead of controller 50 as compared with power conversion unit 100 in FIG. 1.

Converter 10 # is different from converter 10 in that first bridges 11a, 11b are separately provided corresponding to second bridge 12 and third bridge 13, respectively, and that first bridge 11 is provided to second bridge 12 and third bridge 13 in common.

First bridges 11a, 11b are connected in parallel to input end Ni. Furthermore, first bridge 11a is connected to second bridge 12 through transformer 15a, and first bridge 11b is connected to third bridge 13 through transformer 15b. Similarly to converter 10, second bridge 12 outputs first voltage Vo1 to first DC voltage end VE1 configured of first and second terminals P1, P2, and third bridge 13 outputs second voltage Vo1 to second DC voltage end VE2 configured of third and fourth terminals P3, P4.

In converter 10 #, the power transmission between battery BAT and first DC voltage end VE1 by first bridge 11a and second bridge 12 and the power transmission between battery BAT and second DC voltage end VE2 by first bridge 11b and third bridge 13 are executed in parallel.

Controller 55 # includes subtraction units 61a, 61b, gain multiplication units 62a, 62b, and phase shift amount control units 70a, 70b. Similarly to controller 50, subtraction unit 61a and gain multiplication unit 62a generate command value REF1 bringing first voltage Vo1 close to voltage target value Vo*. Similarly to controller subtraction unit 61b and gain multiplication unit 62b generate command value REF2 bringing second voltage Vo1 closer to voltage target value Vo*. Also in controller 55 #, voltage target value Vo* can be individually set between first voltage Vo1 and second voltage Vo2.

Similarly to arithmetic units 73a, 73b in FIG. 3, phase shift amount control unit calculates phase shift amount θ12 from command value REF1 and calculates phase shift amount θ13 from command value REF2. In converter 10 #, phase shift amount θ12 can be defined by the phase shift amount between the AC voltage of first bridge 11a and the AC voltage (Vinvs) of second bridge 12. Similarly, phase shift amount θ13 can be defined by the phase shift amount between the AC voltage of first bridge 11b and the AC voltage (Vinvt) of third bridge 13.

Phase shift amount control unit 70a generates gate signals of the plurality of switching elements constituting first bridge 11a and second bridge 12 so as to generate phase shift amount θ12. Similarly, phase shift amount control unit 70b generates the gate signals of the plurality of switching elements constituting first bridge 11b and third bridge 13 so as to generate phase shift amount θ13.

Thus, also in power conversion unit 100 #, when converter 10 # is controlled by controller 50 #, first voltage Vo1 and second voltage Vo2 can be brought close to voltage target value Vo* similarly to phase shift pattern 1A by controller 50 in power conversion unit 100. Phase shift patterns 1B, 1C, and 2A to 2C can also be applied to the switching control of converter 10 #.

As described above, also in power conversion unit 100 #, the output voltage control of first voltage Vo1 and second voltage Vo2 can be performed with the power transmission between battery BAT connected to input end Ni, and first DC voltage end VE1 and second DC voltage end VE2.

When battery BAT is non-connected with input end Ni, the switching of first bridges 11a, 11 b is stopped, and the control of the non-connection mode described in the third embodiment can be executed by second bridge 12 and third bridge 13. That is, converter 10 # can be used in power conversion unit 100Y.

In the present embodiments described above, as long as the power transmission accompanied by the output voltage control (Vo1, Vo2) can be performed between input end Ni and first DC voltage end VE1 and second DC voltage end VE2, the circuit configurations (parts of converter 10, 10 #) of power conversion units 100X, 100Y are arbitrary. In addition, the output voltage control by the converter is not limited to the exemplified control related to the phase shift pattern, but any control method can be applied.

In the present embodiments, it is assumed that the “DC power supply” can be charged, but the DC power supply that only performs the discharge (power supply) of a power generating element or the like may be connected to input ends Ni of power conversion units 100X, 100Y. In this case, the switching of first bridge 11 to third bridge 13 is controlled so as to limit a power transmission direction in converter 10 (only the power transmission from first bridge 11 to second bridge 12 and third bridge 13).

In addition, in the power conversion device of the present embodiments, it will be confirmably described that the interconnection mode of the output sides (first DC voltage end VE1 and second DC voltage end VE2) of the power conversion units 100X, 100Y is not limited to the connection mode by the illustrated output connector 511 to 516. That is, each of first DC voltage end VE1 and second DC voltage end VE2 of power conversion units 100X, 100Y can be connected to the other first DC voltage end VE1 or second DC voltage end VE2 in an arbitrary manner. In addition, the number of power conversion units 100X, 100Y constituting the power conversion device can be set to any number.

In addition, each of the controllers 50 to 53, 55, 50 # can be configured by a microcomputer or the like that executes predetermined control arithmetic operation described above by software processing. At least a part of controllers 50 to 53, 55, can be configured using a circuit such as a field programmable gate array (FGPA) and an application specific integrated circuit (ASIC). That is, each function of controllers 50 to 53, 55, 50 # can be configured based on a computer, or at least a part of each function of controllers 50 to 53, 55, 50 # can be configured using the circuit such as the FPGA and the ASIC. In addition, at least a part of the function of each functional block can be configured by an analog circuit.

Although the present disclosure describes various embodiments and examples, the various features, aspects, and functions described in one or the plurality of embodiments are not limited to the application of the specific embodiment, but can be applied to the embodiments alone or in various combinations.

Accordingly, numerous modifications not illustrated are assumed within the scope of the technique of the present disclosure. For example, the case where at least one component is deformed, added, or omitted, and the case where at least one component is extracted and combined with components of other embodiments are included.

It should be considered that the disclosed embodiments are an example in all respects and not restrictive. The technical scope of the present disclosure is defined by not the description above, but the claims, and it is intended that all modifications within the meaning and scope of the claims are included in the present invention.

### REFERENCE SIGNS LIST

10: converter, 11, 11a, 11b: first bridge, 12: second bridge, 13: third bridge, 15, 15b: transformer, 16: primary winding, 17, 18: secondary winding, 19: core, 50, 51 to 53, 55: controller, 65, 76: average value calculation unit, 70, 70a, 70b, 71, 72: phase shift amount control unit, 81a, 81b: voltage detector, 82, 82a, 82b: current detector, 100, 100X, 100X1 to 100XN, 100Y, 100Y1 to 100YN, 100 #, 101 to 105: power conversion unit, 150 to 154: inverter, 200 to 206: power conversion system, 300 to 303: AC power system, 500, 500a, 500b, 501 to 506: power conversion device, 511 to 514: output connector, BAL, REF, REF1, REF2: command value, BAT, BAT1 to BATN: battery (DC power supply), C1: first capacitor, C2: second capacitor, GSap, GSas, GSat, GSbp, GSbs, GSbt, GScp, GScs, GSct. GSdp, GSds, GSdsp, GSdt: gate signal, IO1: first current, Io2: second current, NL1 to NL3, PL1 to, PL3: power line, Ni: input end, P1: first terminal, P2: second terminal, P3: third terminal, P4: fourth terminal, VDIF: voltage difference, VE1, VE11 to VEIN: first DC voltage end, VE2, VE21 to VE2N: second DC voltage end, Vav: average voltage, Vin: input voltage (power conversion unit), Vin1 to Vin4: input voltage (DC/AC converter), Vo*: voltage target value, Vo1, Vo11 to Vo1N: first voltage, Vo2, Vo21 to Vo2N: second voltage, Vout1 to Vout4: output voltage (power conversion device)

1. A power conversion unit comprising:
an input end to connect with a DC power supply;
a first DC voltage end configured of a first terminal and a second terminal;
a second DC voltage end configured of a third terminal and a fourth terminal;
a converter to perform DC/DC power conversion accompanied by power transmission between the input end, and the first DC voltage end and the second DC voltage end; and
a controller to control the converter,
the controller generating a control command for the converter controlling a first voltage at the first DC voltage end and a second voltage at the second DC voltage end to a voltage target value, wherein
the controller
operates the converter by selecting one of a first mode in which the first voltage and the second voltage are controlled accompanied by power transmission between the input end, and the first DC voltage end and the second DC voltage end and a second mode in which the first voltage and the second voltage are controlled accompanied by power transmission between the first DC voltage end and the second DC voltage end, based on a state of a power supply from the DC power supply through the input end.

2. The power conversion unit according to claim 1, further comprising:
a first voltage detector to detect the first voltage; and
a second voltage detector to detect the second voltage,
wherein the controller calculates a first command value bringing a detection voltage of the first voltage detector close to the voltage target value and a second command value bringing a detection voltage of the second voltage detector close to the voltage target value, and generates the control command based on the first command value and the second command value.

3. The power conversion unit according to claim 2, further comprising:
a first current detector to detect a first current input to and output from the first DC voltage end; and
a second current detector to detect a second current input to and output from the second DC voltage end,
wherein the first command value is calculated such that a detected current by the first current detector is brought close to a target value of the first current calculated based on a voltage deviation of a detection voltage of the first voltage detector with respect to the voltage target value, and
the second command value is calculated such that a detected current by the second current detector is brought close to a target value of the second current calculated based on a voltage deviation of a detection voltage of the second voltage detector with respect to the voltage target value.

4. The power conversion unit according to claim 1, further comprising:
a first voltage detector to detect the first voltage; and
a second voltage detector to detect the second voltage,
wherein the controller calculates a first command value bringing an average voltage of detection voltages of the first voltage detector and the second voltage detector close to the voltage target value and a second command value bringing a voltage difference between the detection voltage of the first voltage detector and the detection voltage of the second voltage detector close to zero, and generates the control command based on the first command value and the second command value.

5. The power conversion unit according to claim 4, further comprising an input current detector to detect an input current from the DC power supply to the input end,
wherein the first command value is calculated such that a detected current by the input current detector is brought close to a target value of the input current calculated based on a voltage deviation of the average voltage with respect to the voltage target value.

6. The power conversion unit according to claim 1, wherein
the controller
operates the converter in the first mode when the DC power supply, which is usable, is electrically connected to the input end, and
operates the converter in the second mode when the DC power supply is not electrically connected to the input end or the DC power supply, which is unusable, is electrically connected to the input end.

7. The power conversion unit according to claim 1, wherein the first DC voltage end and the second DC voltage end are connected in parallel or in series using the first to fourth terminals.

8. The power conversion unit according to claim 1, wherein at least one of the first DC voltage end and the second DC voltage end is connected to the first DC voltage end or the second DC voltage end of another power conversion unit using at least a part of the first to fourth terminals in a power conversion device including a plurality of the power conversion units.

9. The power conversion unit according to claim 7, wherein the first DC voltage end and the second DC voltage end are further electrically connected to an AC power system through a DC/AC converter.

10. A power conversion device comprising:
a plurality of the power conversion units according to claim 1; and
an output connector to interconnect the first DC voltage end and the second DC voltage end of the plurality of power conversion units using the first to fourth terminals of each of the power conversion units.

11. A power conversion device comprising:
a plurality of the power conversion units according to claim 1; and
an output connector to interconnect the first DC voltage end and the second DC voltage end of the plurality of power conversion units using the first to fourth terminals of each of the power conversion units,
wherein in each of the plurality of power conversion units, the converter operates in the first mode when the DC power supply is connected to the input end, and the converter operates in the second mode when the DC power supply is non-connected with the input end.

12. The power conversion device according to claim 10, wherein the output connector connects the first DC voltage end of each of the power conversion units to the first DC voltage end or the second DC voltage end of another of the power conversion units in parallel or in series, and connects the second DC voltage end of each of the power conversion units to the first DC voltage end or the second DC voltage end of another of the power conversion units in parallel or in series.

13. The power conversion device according to claim 12, wherein the output connector connects the first DC voltage end and the second DC voltage end in series in at least a part of the plurality of power conversion units.

14. The power conversion device according claim 10, wherein the output connector electrically connects at least a part of the first DC voltage end and the second DC voltage end of the plurality of interconnected power conversion units to an AC power system through a DC/AC converter.

15. The power conversion device according to claim 10, wherein
the output connector generates one or a plurality of output voltages from the N (N: a natural number of at least 2) power conversion units in which the first DC voltage end and the second DC voltage end are interconnected, and
each of the output voltages is controlled to an integral multiple of the voltage target value less than or equal to N.
